(19) United States
(12) Patent Application Publication
(10) Pub. No.: US 2022/0025307 A1
(43) Pub. Date: Jan. 27, 2022

(54) WIPING DETERGENT COMPOSITION FOR TEXTILE PRODUCTS

(71) Applicant: Kao Corporation, Tokyo (JP)

(72) Inventors: Sachiko YOSHIOKA, Wakayama-shi (JP); Mami IMAI, Wakayama-shi (JP); Hironori KOJIMA, Wakayama-shi (JP); Toshimasa KUME, Wakayama-shi (JP); Wakana MIYASHITA, Wakayama-shi (JP)

(73) Assignee: Kao Corporation, Tokyo (JP)

(21) Appl. No.: 17/311,636

(22) PCT Filed: Dec. 23, 2019
(86) PCT No.: PCT/JP2019/050420

§ 371 Date: Jun. 7, 2021

(30) Foreign Application Priority Data
Dec. 28, 2018 (JP) 2018-246573
Dec. 28, 2018 (JP) 2018-246576

(51) Int. Cl. C11D 17/04; C11D 11/00; C11D 1/831; C11D 1/835; C11D 3/43; C11D 3/20; C11D 3/12; D06L 1/04; D06F 43/00

(52) U.S. Cl. CPC C11D 17/049; C11D 11/0017; C11D 1/831; C11D 1/835; C11D 1/721; C11D 3/2068; C11D 3/124; D06L 1/04; D06F 43/007; C11D 3/43

(57) ABSTRACT

Provided are a wiping detergent composition for textile products capable of, when wiping a stain derived from food or the like attached to a textile product using a detergent liquid, not only reducing the degree of soiling of the stain portion, but also reducing the spread of the stain around the stain portion, and a method for removing a stain attached to a textile product using the same. A wiping detergent composition for textile products containing the following component (a1) in an amount of 0.3 mass % or more and 10 mass % or less, the following component (b) in an amount of 0.1 mass % or more, and water, wherein the mass ratio of the content of component (a1) to the content of component (b), (a1)/(b), is 0.6 or more and 50 or less,
component (a1): one or more surfactants selected from a nonionic surfactant with an HLB of 9 or more and 16.0 or less and an anionic surfactant, and
component (b): an organic solvent having a hydroxyl group with a ClogP of −2.0 or more and less than 1.0.

### FIELD OF THE INVENTION

The present invention relates to a wiping detergent composition for textile products and a washing sheet using the detergent composition, and a method for removing a stain attached to a textile product.

### BACKGROUND OF THE INVENTION

Clothes after washed become dirty as a stain such as food or the like, sweat or a sebum stain is attached thereto while they are worn. When stains are attached to clothes while they are worn, it is often the case that the clothes are taken off after worn and the clothes after taken off are washed using washing machines. However, if clothes which people are wearing while being out become spotted with a stain such as a food stain or the like, they have to spend their time with the stain remaining attached, and often feel unpleasant. For removing food-derived stains attached to textile products, stain removing agent compositions for textile products have been known.

For example, JP-A 2001-181683 discloses a stain removing agent composition for textile products capable of significantly reducing the frequency of occurrence of a stain residue or a ring stain, the composition containing an organic solvent with a specific boiling point, a lower alcohol and a surfactant. JP-A H11-502888 discloses a dry cleaning and spot removal composition, which can be directly applied to isolated spots and stains on fabrics, containing a polyacrylate emulsifier, an organic cleaning solvent, optionally a detersive surfactant, and water. JP-A 2003-105399 discloses a stain removing method including applying a specific absorbent pad to a fabric when removing a stain on the fabric using a stain removing agent composition containing a water-soluble organic solvent and a surfactant. All these patent literatures use surfactants or organic solvents as stain removing components.

### SUMMARY OF THE INVENTION

One of the problems with the aforementioned stain removing agent compositions for textile products is a ring stain. A ring stain refers to a phenomenon in which, when a detergent liquid is used to remove a stain component such as a stain caused by a surfactant attached to a textile product as a washing component, a food stain attached to a textile product or the like, the stain portion on the textile product is pushed out by the edgemost portion of the detergent liquid to be concentrically spread out around the stain portion and shaped into a ring on the textile product. However, existing stain removing agent compositions for textile products are insufficient to solve the aforementioned ring stain problem. The present inventors have found that there has been a problem of the aforementioned ring stain phenomenon causing a stain attached to a textile product to be spread out around the stain portion, thereby causing a light stain to be spread over the textile product to make it appear as if the area of the stain has expanded, even if the degree of soiling of the stain portion attached to the textile product is reduced by wiping the stain with a detergent liquid.

In addition, excellent detergency against stains attached to textile products has been conventionally required of the aforementioned stain removing agent compositions for textile products. Further, when stains attached to textile products are wiped with washing sheets impregnated with detergent compositions, users touch the detergent compositions by hand through the washing sheets impregnated therewith. In this case, the users may have an unpleasant slimy feeling, such as a slimy sensation on their hands, during the use of the washing sheets.

One embodiment of the present invention relates to a wiping detergent composition for textile products capable of, when wiping a stain derived from food or the like attached to a textile product with a detergent liquid, not only reducing the degree of soiling of the stain portion, but also reducing the spread of the stain around the stain portion, a wiping washing sheet for textile products using the detergent composition, and a method for removing a stain attached to a textile product.

In addition, one embodiment of the present invention relates to a wiping detergent composition for textile products capable of reducing a slimy feeling when the detergent composition is touched by hand while maintaining detergency against stains attached to textile products, a wiping washing sheet for textile products using the detergent composition, and a method for removing a stain attached to a textile product.

The present invention relates to a wiping detergent composition for textile products containing the following component (a1) in an amount of 0.3 mass % or more and 10 mass % or less, the following component (b) in an amount of 0.1 mass % or more, and water,

component (a1): one or more surfactants selected from a nonionic surfactant with an HLB of 9 or more and 16.0 or less and an anionic surfactant; and

component (b): an organic solvent having a hydroxyl group with a ClogP of −2.0 or more and less than 1.0,

wherein the mass ratio of the content of component (a1) to the content of component (b), (a1)/(b), is 0.6 or more and 50 or less, which is hereinafter referred to as a first mode of the present invention.

In addition, the present invention relates to a wiping detergent composition for textile products containing the following component (a2) in an amount of 0.1 mass % or more and 10 mass % or less, the following component (b) in an amount of 0.1 mass % or more, the following component (d), and water,

component (a2): a surfactant;

component (b): an organic solvent having a hydroxyl group with a ClogP of −2.0 or more and less than 1.0; and

component (d): a silicon compound,

wherein the mass ratio of the content of component (a2) to the content of component (b), (a2)/(b), is 0.6 or more and 50 or less, which is hereinafter referred to a second mode of the present invention.

Moreover, the present invention relates to a wiping washing sheet for textile products including the wiping detergent composition for textile products and a base material.

Further, the present invention relates to a method for removing a stain attached to a textile product including, impregnating the stained portion of the textile product with the wiping detergent composition for textile products, and thereafter wiping the stained portion with a base material.

Furthermore, the present invention relates to a method for removing a stain attached to a textile product including, impregnating a base material with the wiping detergent composition for textile products, and thereafter wiping the stained portion of the textile product with the impregnated base material.

According to the first mode of the present invention, provided are a wiping detergent composition for textile products capable of, when wiping a stain derived from food or the like attached to a textile product with a detergent liquid, not only reducing the degree of soiling of the stain portion, but also reducing the spread of the stain around the stain portion, a wiping washing sheet for textile products using the detergent composition, and a method for removing a stain attached to a textile product.

According to the second mode of the present invention, provided are a wiping detergent composition for textile products capable of reducing a slimy feeling when the detergent composition is touched by hand while maintaining detergency against stains attached to textile products, a wiping washing sheet for textile products using the detergent composition, and a method for removing a stain attached to a textile product.

### EMBODIMENTS OF THE INVENTION

### <Wiping Detergent Composition for Textile Products>

### [First Mode]

The wiping detergent composition for textile products of the first mode of the present invention is a detergent composition containing the aforementioned component (a1) in an amount of 0.3 mass % or more and 10 mass % or less, the aforementioned component (b) in an amount of 0.1 mass % or more, and water, wherein the mass ratio of the content of component (a1) to the content of component (b), (a1)/(b), is 0.60 or more and 50 or less, which is suitable as a detergent composition for wiping stains attached to textile products.

[Component (a1)]

Component (a1) of the present invention is one or more surfactants selected from (a11) a nonionic surfactant with an HLB of 9 or more and 16.0 or less (hereinafter also referred to as component (a11)) and (a12) an anionic surfactant (hereinafter also referred to as component (a12)). Component (a1) has the effect of washing stains attached to textile products.

In the present invention, when component (a11) is a nonionic surfactant having a polyoxyethylene group, the HLB is determined by Griffin's method represented by the following general formula (1):

HLB value=[(molecular weight of polyoxyethylene group part of component (a11))/(molecular weight of component (a11))]×20 (1)

Note that the molecular weight of the polyoxyethylene group part of component (a11) is calculated using a value of the average number of added moles of the polyoxyethylene group.

In addition, in the case of a nonionic surfactant having no polyoxyethylene group, the HLB can be determined by Davies' method. Here, when HLB is calculated by Davies' method, it can be calculated using a method described on pages 24 to 25 in “Surfactants-Physical Properties, Applications and Chemical Ecology” (Fumio KITAHARA et al., KODANSHA SCIENTIFIC LTD., May 20, 1990, 7th printing publication).

The HLB of component (a11) is 9 or more, preferably 9.5 or more, more preferably 10 or more, furthermore preferably 10.5 or more and furthermore preferably 11 or more, and 16.0 or less, preferably 15.0 or less, more preferably 14.5 or less, further preferably 14 or less, furthermore preferably 13 or less and furthermore preferably 12 or less from the viewpoint of excellent detergency against stains attached to textile products (hereinafter also referred to as the viewpoint of detergency).

Component (a11) is preferably a nonionic surfactant including an ethyleneoxy group with an HLB of 9 or more and 16.0 or less from the viewpoints of improving detergency and reducing the spread of stains. From the viewpoint of improving detergency, the nonionic surfactant including an ethyleneoxy group with an HLB of 9 or more and 16.0 or less is preferably a nonionic surfactant represented by the following general formula (a11) with an HLB of 9 or more, preferably 9.5 or more, more preferably 10 or more, furthermore preferably 10.5 or more and furthermore preferably 11 or more, and 16.0 or less, preferably 15.0 or less, more preferably 14.5 or less, further preferably 14 or less, furthermore preferably 13 or less and furthermore preferably 12 or less,

R^{11a}(CO)ₘ₁O-(A^{11a}O)ₙ₁—R¹² (a11)

wherein R^{11a} is an aliphatic hydrocarbon group with 9 or more and 18 or less carbons, and R^{12a} is a hydrogen atom or a methyl group; CO is a carbonyl group, and m1 is a number of 0 or 1; A^{11a}O group is an alkyleneoxy group including an ethyleneoxy group with 2 or more and 4 or less carbons; and n1 is an average number of added moles and a number of 3 or more and 50 or less.

In the general formula (a11), R^{11a} is an aliphatic hydrocarbon group with 9 or more and 18 or less carbons. If chemical structures other than R^{11a} in the general formula (a11) are the same, the larger the number of carbons of R^{11a} is, the lower a value of the HLB is. From the viewpoint of controlling a value of the HLB to further enhance detergency against stains attached to textile products, R^{11a} has 9 or more, preferably 10 or more and more preferably 11 or more, and preferably 18 or less, more preferably 16 or less, further preferably 15 or less and furthermore preferably 14 or less carbons.

R^{11a} is an aliphatic hydrocarbon group and preferably a group selected from an alkyl group and an alkenyl group from the viewpoint of further enhancing detergency against stains attached to textile products.

In the general formula (a11), A^{11a}O group is an alkyleneoxy group including an ethyleneoxy group with 2 or more and 4 or less carbons, preferably an alkyleneoxy group including an ethyleneoxy group with 2 or more and 3 or less carbons and more preferably an ethyleneoxy group. A^{11a}O group may be an alkyleneoxy group including an ethyleneoxy group and another alkyleneoxy group, for example, a propyleneoxy group. The another alkyleneoxy group is preferably a propyleneoxy group. When A^{11a}O group includes an ethyleneoxy group and a propyleneoxy group, the ethyleneoxy group and the propyleneoxy group may be bonded in block or bonded at random. An ethyleneoxy group makes a value of HLB higher than a propyleneoxy group.

In the general formula (a11), n1 is the number average number of added moles of A^{11a}O group and a number of 3 or more and 50 or less. If chemical structures other than n1 in the general formula (a11) are the same, the larger a number of n1 is, the higher a value of the HLB is, and the smaller a number of n1 is, the lower a value of the HLB is. n is 3 or more, preferably 4 or more, more preferably 5 or more and further preferably 6 or more, and 50 or less, preferably 40 or less, more preferably 30 or less, further preferably 20 or less, furthermore preferably 15 or less, furthermore preferably 12 or less, furthermore preferably 10 or less, furthermore preferably 8 or less and furthermore preferably 7 or less from the viewpoint of controlling a value of the HLB to further enhance detergency against stains attached to textile products.

Specific examples in the case of a nonionic surfactant having no polyoxyethylene group include one or more selected from a sucrose fatty acid ester, a glycerin fatty acid ester, a sorbitan fatty acid ester, an alkyl glycoside and a glyceryl monoether, provided that the nonionic surfactant having no polyoxyethylene group has an HLB of 9 or more and 15 or less according to Davies' method.

Specific examples of component (a12) of the present invention include one or more anionic surfactants selected from the following components (a121), (a122), (a123) and (a124):

component (a121): an alkyl or alkenyl sulfate ester salt;

component (a122): a polyoxyalkylene alkyl ether sulfate ester salt or a polyoxyalkylene alkenyl ether sulfate ester salt;

component (a123): an anionic surfactant having a sulfonate group; and

component (a124): a fatty acid with 10 or more and 20 or less carbons or a salt thereof (provided that component (a123) is excluded).

More specific examples of component (a121) include one or more anionic surfactants selected from an alkyl sulfate ester salt whose alkyl group has 10 or more and 18 or less carbons and an alkenyl sulfate ester salt whose alkenyl group has 10 or more and 18 or less carbons. Component (a121) is preferably an alkyl sulfate ester salt whose alkyl group has 12 or more and 14 or less carbons and more preferably a sodium alkyl sulfate whose alkyl group has 12 or more and 14 or less carbons from the viewpoint of improving detergency.

More specific examples of component (a122) include one or more anionic surfactants selected from a polyoxyalkylene alkyl sulfate ester salt whose alkyl group has 10 or more and 18 or less carbons and the average number of added moles of the alkyleneoxy group of which is 1 or more and 3 or less and a polyoxyalkylene alkenyl ether sulfate ester salt whose alkenyl group has 10 or more and 18 or less carbons and the average number of added moles of the alkyleneoxy group of which is 1 or more and 3 or less. Component (a122) is preferably a polyoxyethylene alkyl sulfate ester salt the average number of added moles of the ethyleneoxy group of which is 1 or more and 2.2 or less, more preferably a polyoxyethylene alkyl sulfate ester salt whose alkyl group has 12 or more and 14 or less carbons and the average number of added moles of the ethyleneoxy group of which is 1 or more and 2.2 or less, and further preferably their sodium salts from the viewpoint of improving detergency.

The anionic surfactant having a sulfonate group of component (a123) is an anionic surfactant having a sulfonate as a hydrophilic group.

More specific examples of component (a123) include one or more anionic surfactants selected from an alkylbenzene sulfonate whose alkyl group has 10 or more and 18 or less carbons, an alkenylbenzene sulfonate whose alkenyl group has 10 or more and 18 or less carbons, an alkane sulfonate whose alkyl group has 10 or more and 18 or less carbons, an α-olefin sulfonate whose α-olefin part has 10 or more and 18 or less carbons, an α-sulfo fatty acid salt whose fatty acid part has 10 or more and 18 or less carbons and an α-sulfo fatty acid lower alkyl ester salt whose fatty acid part and ester part have 10 or more and 18 or less carbons and 1 or more and 5 or less carbons, respectively. Component (a123) is preferably an alkylbenzene sulfonate whose alkyl group has 11 or more and 14 or less carbons and more preferably a sodium alkylbenzene sulfonate whose alkyl group has 11 or more and 14 or less carbons from the viewpoint of improving detergency.

The fatty acid with 10 or more and 20 or less carbons or a salt thereof of component (a124) means a fatty acid in which the carboxyl group and the hydrocarbon group bonded to the carboxyl group have 10 or more and 20 or less carbons in total or a salt thereof. Component (a124) has 10 or more and preferably 12 or more, and 20 or less and preferably 18 or less carbons.

The salts of anionic surfactants of components (a121) to (a124) are preferably alkali metal salts, more preferably sodium salts or potassium salts, and further preferably sodium salts.

Component (a1) is preferably one or more selected from a nonionic surfactant including an ethyleneoxy group with an HLB of 9 or more and 16.0 or less and an anionic surfactant including any of a sulfonic acid group, a sulfate group and salts thereof, and more preferably one or more selected from a nonionic surfactant represented by the aforementioned general formula (a11) with an HLB of 9 or more and 16.0 or less, component (a121), component (a122) and component (a123) from the viewpoint of further enhancing detergency against stains attached to textile products.

[Component (b)]

Component (b) of the present invention is an organic solvent having a hydroxyl group with a ClogP of −2.0 or more and less than 1.0. When component (b) is used with component (a1) at a particular ratio, it has the effect of reducing the spread of a stain attached to a textile product around the stain portion while maintaining the detergency of component (a1) against the stain. In the present invention, used as CLogP is a calculated value calculated using ChemProperty of ChemBioDraw Ultra ver. 14.0 from Perkin Elmer Inc. Note that the larger a value of ClogP is, the higher hydrophobicity is.

The ClogP of component (b) is preferably −1.6 or more and more preferably −1.3 or more from the viewpoint of further reducing the spread of a stain attached to a textile product around the stain portion while maintaining the detergency of component (a1) against the stain by using it with component (a1) at a particular ratio, and preferably 0.8 or less, more preferably 0.5 or less, further preferably 0.2 or less and furthermore preferably 0.1 or less from the same viewpoint.

In terms of further having the effect of reducing the spread of a stain attached to a textile product around the stain portion while maintaining the detergency of component (a1) against the stain by using component (b) with component (a1) at a particular ratio, component (b) is preferably one or more organic solvents having a hydroxyl group selected from the following components (b1) to (b3):

component (b1): an organic solvent having a hydroxyl group with a ClogP of −2.0 or more and less than 1.0, which is a monohydric alcohol with 2 or more and 6 or less carbons;

component (b2): an organic solvent having a hydroxyl group with a ClogP of −2.0 or more and less than 1.0, which is a dihydric or more and dodecahydric or less alcohol with 2 or more and 12 or less carbons; and

component (b3): an organic solvent having a hydrocarbon group with 1 or more and 8 or less carbons, an ether group and a hydroxyl group with a ClogP of −2.0 or more and less than 1.0 (provided that an aromatic group is excluded from the hydrocarbon group).

Specific examples of components (b1) to (b3) are listed below. Note that the numerals inside the parentheses are calculated values (CLogP) of the components calculated using ChemProperty of ChemBioDraw Ultra ver. 14.0 from Perkin Elmer Inc.

Examples of component (b1) include ethanol (−0.24), 1-propanol (0.29) and 2-propanol (0.07).

Examples of component (b2) include ethylene glycol (−1.4), propylene glycol (−1.1), butylene glycol (−0.73), hexylene glycol (−0.02), diethylene glycol (−1.3), triethylene glycol (−1.5), tetraethylene glycol (−1.66), dipropylene glycol (−0.69), tripropylene glycol (−0.55) and glycerin (−1.5).

Examples of component (b3) include diethylene glycol monomethyl ether (−0.78), diethylene glycol dimethyl ether (−0.26), triethylene glycol monomethyl ether (−0.96), diethylene glycol monoethyl ether (−0.39), diethylene glycol diethyl ether (0.52), diethylene glycol monobutyl ether (0.67), dipropylene glycol monomethyl ether (−0.16), dipropylene glycol monoethyl ether (0.23), tripropylene glycol monomethyl ether (−0.03), 1-methoxy-2-propanol (−0.30), 1-ethoxy-2-propanol (0.09), 1-methylglycerin ether (−1.43), 2-methylglycerin ether (−0.73), 1,3-dimethylglycerin ether (−0.67), 1-ethylglycerin ether (−1.04), 1,3-diethylglycerin ether (0.11), triethylglycerin ether (0.83) and 1-pentylglyceryl ether (0.54).

Component (b) is preferably one or more selected from the aforementioned components (b1) and (b2) and more preferably one or more selected from ethanol, 2-propanol, ethylene glycol and propylene glycol from the viewpoint of being able to improve detergency against a stained center and reduce the spread of the stain from the center.

When the wiping detergent composition for textile products of the first mode of the present invention contains the aforementioned components (b1) and (b2), the mass ratio of the content of component (b1) to the content of component (b2), (b1)/(b2), is preferably 0.1 or more, more preferably 0.2 or more, further preferably 0.5 or more and furthermore preferably 1 or more, and preferably 20 or less, more preferably 15 or less, further preferably 10 or less, furthermore preferably 5 or less and furthermore preferably 3 or less from the viewpoint of a feeling during use.

In the present invention, when components (b1) and (b2) are used together, the proportion of the total of components (b1) and (b2) in component (b) is preferably 60 mass % or more and more preferably 80 mass % or more, and preferably 100 mass % or less and may be 100 mass %.

In the present invention, it is preferable to use ethanol as component (b1) from the viewpoint of a feeling during use, and it is preferable to use as component (b2) one or more selected from ethylene glycol, propylene glycol, glycerin, diethylene glycol and dipropylene glycol from the viewpoint of liquid stability.

[Component (c)]

The wiping detergent composition for textile products of the first mode of the present invention can contain as component (c) an organic solvent having a hydroxyl group with a ClogP of 1.0 or more and 2.2 or less. In the present invention, component (c) has the effect of reducing the spread of a stain around the stain portion by using it with component (b) at a particular ratio. Component (c) is preferably an organic solvent having a hydrocarbon group with 1 or more and 8 or less carbons, an ether group and a hydroxyl group with a ClogP of 1.0 or more and 2.2 or less in terms of having the effect of reducing the spread of a stain around the stain portion.

Specific examples of component (c) are listed below. Note that the numerals inside the parentheses are calculated values (CLogP) of the components calculated using ChemProperty of ChemBioDraw Ultra ver. 14.0 from Perkin Elmer Inc.

The ClogP of component (c) is preferably 1.1 or more from the viewpoint of further reducing the spread of a stain around the stain portion by using it with component (b) at a particular ratio, and preferably 2 or less, more preferably 1.6 or less and further preferably 1.4 or less from the same viewpoint.

Examples of component (c) include 2-pentylglyceryl ether (1.25), 1-octylglyceryl ether (2.1), 2-ethylhexylglyceryl ether (2.0), 2-phenoxyethanol (1.2), diethylene glycol monophenyl ether (1.25), triethylene glycol monophenyl ether (1.08), 2-benzyloxyethanol (1.1) and diethylene glycol monobenzyl ether (1.0).

### [Composition and Others]

The wiping detergent composition for textile products of the first mode of the present invention contains component (a1) in an amount of 0.3 mass % or more, preferably 0.4 mass % or more and more preferably 0.5 mass % or more from the viewpoint of further enhancing detergency against stains attached to textile products, and 10 mass % or less, preferably 9 mass % or less, more preferably 8 mass % or less and further preferably 7 mass % or less from the viewpoint of the detergent composition applied to textile products being less sticky to the touch.

In the wiping detergent composition for textile products of the first mode of the present invention, the content of component (a1) in all surfactants contained in the composition is preferably 20 mass % or more, more preferably 40 mass % or more, further preferably 60 mass % or more, furthermore preferably 80 mass % or more and furthermore preferably 90 mass % or more, and preferably 100 mass % or less and may be 100 mass % from the viewpoint of detergency.

The wiping detergent composition for textile products of the first mode of the present invention contains component (b) in an amount of 0.1 mass % or more, preferably 0.2 mass % or more, more preferably 0.3 mass % or more and further preferably 0.5 mass % or more, and preferably 15 mass % or less, more preferably 10 mass % or less, further preferably 5 mass % or less, furthermore preferably 4 mass % or less, furthermore preferably 3 mass % or less, furthermore preferably 2 mass % or less and furthermore preferably 1.5 mass % or less from the viewpoint of attaining both detergency against a stain attached to a textile product and reduction in the spread of the stain around the stain portion.

In the wiping detergent composition for textile products of the first mode of the present invention, the mass ratio of the content of component (a1) to the content of component (b), (a1)/(b), is 0.60 or more, preferably 0.70 or more, more preferably 0.80 or more, further preferably 1.0 or more, furthermore preferably 2.0 or more and furthermore preferably 3.0 or more from the viewpoint of further enhancing detergency against stains attached to textile products, and 50 or less, preferably 30 or less, more preferably 10 or less, further preferably 7 or less, furthermore preferably 5 or less and furthermore preferably 4 or less from the viewpoint of reducing the spread of a stain around the stained portion on a textile product.

The wiping detergent composition for textile products of the first mode of the present invention contains component (c) in an amount of preferably 0.1 mass % or more and further preferably 0.2 mass % or more from the viewpoint of attaining both detergency against a stain attached to a textile product and reduction in the spread of the stain around the stain portion, and preferably 5 mass % or less, more preferably 4 mass % or less, further preferably 3 mass % or less, furthermore preferably 2 mass % or less and furthermore preferably 1 mass % or less from the same viewpoint.

In the wiping detergent composition for textile products of the first mode of the present invention, the mass ratio of the content of component (b) to the content of component (c), (b)/(c), is preferably 1 or more, more preferably 1.5 or more and further preferably 2 or more from the viewpoint of attaining both reduction in the spread of a stain around the stain portion, and preferably 50 or less, more preferably 40 or less, further preferably 30 or less, furthermore preferably 20 or less, furthermore preferably 10 or less, furthermore preferably 8 or less, furthermore preferably 6 or less and furthermore preferably 4 or less from the same viewpoint.

The wiping detergent composition for textile products of the first mode of the present invention can contain the following components (e1) to (e3) as optional components:

component (e1): a hydroxylamine compound including an amino group and a hydroxyl group with 1 or more and 8 or less carbons;

component (e2): a carboxylic acid with 1 or more and 9 or less carbons or a salt thereof; and

component (e3): a fragrance compound, an antioxidant, a preservative, a dye or a pH adjuster (provided that the aforementioned components (a1), (b), (c) and (e1) to (e2) are excluded).

The amino group in component (e1) is preferably one or more amino groups selected from a primary amino group and a secondary amino group. Specific examples of component (e1) include one or more compounds selected from monoethanolamine, mono lower alkyl (with 1 or more and 3 or less carbons) amino monoethanolamine, mono lower alkyl (with 1 or more and 3 or less carbons) amino diethanolamine, di lower alkyl (with 1 or more and 3 or less carbons) amino monoethanolamine, triethanolamine and tris(hydroxymethyl)aminomethane. Component (e1) may be contained as an ammonium ion depending on pH in the detergent composition of the first mode of the present invention. The wiping detergent composition for textile products of the first mode of the present invention can contain component (e1) in the range of 0.1 mass % or more and 2 mass % or less.

Specific examples of component (e2) include one or more compounds selected from formic acid, glycolic acid, lactic acid, citric acid, maleic acid, fumaric acid, salicylic acid, benzoic acid and salts thereof. Examples of the salts include alkyl metal salts such as sodium salts or the like and alkaline earth metal salts such as magnesium salts, calcium salts or the like. The wiping detergent composition for textile products of the first mode of the present invention can contain component (e2) in the range of 0.1 mass % or more and 3 mass % or less.

The wiping detergent composition for textile products of the first mode of the present invention contains water. As the water, ion exchange water, distilled water, sterilized purified water, tap water or water containing 0.1 mg/kg or more and 5 mg/kg or less of hypochlorite such as sodium hypochlorite or the like can be used.

The wiping detergent composition for textile products of the first mode of the present invention contains water in an amount of preferably 70 mass % or more, more preferably 75 mass % or more and further preferably 80 mass % or more, and preferably 99 mass % or less, more preferably 98 mass % or less and further preferably 97 mass % or less.

The pH of the wiping detergent composition for textile products of the first mode of the present invention at 25° C. is preferably 6.0 or more, more preferably 6.5 or more, further preferably 7.0 or more and furthermore preferably 7.5 or more, and preferably 9.0 or less and more preferably 8.0 or less from the viewpoints of washing performance and a sensation on hands and skin. The pH of the detergent composition of the present invention can be measured by a method described in Examples using a glass electrode.

### [Second Mode]

The wiping detergent composition for textile products of the second mode of the present invention is a detergent composition containing the aforementioned component (a2) in an amount of 0.1 mass % or more and 10 mass % or less, the aforementioned component (b) in an amount of 0.1 mass % or more, the aforementioned component (d), and water, wherein the mass ratio of the content of component (a2) to the content of component (b), (a2)/(b), is 0.6 or more and 50 or less, which is suitable as a detergent composition for wiping stains attached to textile products.

[Component (a2)]

Component (a2) of the present invention is a surfactant. Component (a2) has the effect of washing stains attached to textile products. Component (a2) is preferably one or more surfactants selected from (a21) a nonionic surfactant (hereinafter also referred to as component (a21)) and (a22) an anionic surfactant (hereinafter also referred to as component (a22)).

Component (a21) is preferably a nonionic surfactant with an HLB of 9 or more and 15 or less from the viewpoint of being able to further improve detergency against stains attached to textile products. When component (a21) is a nonionic surfactant having a polyoxyethylene group, the HLB is determined by Griffin's method represented by the following general formula (1):

HLB value=[(molecular weight of polyoxyethylene group part of component (a21))/(molecular weight of component (a21))]×20 (1)

Note that the molecular weight of the polyoxyethylene group part of component (a21) is calculated using a value of the average number of added moles of the polyoxyethylene group.

In addition, in the case of a nonionic surfactant having no polyoxyethylene group, the HLB can be determined by Davies' method. Here, when HLB is calculated by Davies' method, it can be calculated using a method described on pages 24 to 25 in “Surfactants-Physical Properties, Applications and Chemical Ecology” (Fumio KITAHARA et al., KODANSHA SCIENTIFIC LTD., May 20, 1990, 7th printing publication).

The HLB of component (a21) is 9 or more, preferably 9.5 or more, more preferably 10 or more, furthermore preferably 10.5 or more and furthermore preferably 11.0, and 15 or less, preferably 14.5 or less, more preferably 14 or less, furthermore preferably 13 or less and furthermore preferably 12 or less from the viewpoint of excellent detergency against stains attached to textile products (hereinafter also referred to as the viewpoint of detergency).

Component (a21) is preferably a nonionic surfactant including an ethyleneoxy group with an HLB of 9 or more and 15 or less from the viewpoints of detergency and the prevention of the spread of stains. From the viewpoint of detergency, the nonionic surfactant including an ethyleneoxy group with an HLB of 9 or more and 15 or less is preferably a nonionic surfactant represented by the following general formula (a21) with an HLB of 9 or more, preferably 9.5 or more, more preferably 10 or more, furthermore preferably 10.5 or more and furthermore preferably 11 or more, and 15 or less, preferably 14.5 or less, more preferably 14 or less, furthermore preferably 13 or less and furthermore preferably 12 or less,

R^{21a}(CO)ₘ₂O-(A^{21a}O)ₙ₂—R^{22a} (a1)

wherein R^{21a} is an aliphatic hydrocarbon group with 9 or more and 18 or less carbons, and R^{22a} is a hydrogen atom or a methyl group; CO is a carbonyl group, and m2 is a number of 0 or 1; A^{21a}O group is an alkyleneoxy group including an ethyleneoxy group with 2 or more and 4 or less carbons; and n2 is an average number of added moles and a number of 3 or more and 50 or less.

In the general formula (a21), R^{21a} is an aliphatic hydrocarbon group with 9 or more and 18 or less carbons. If chemical structures other than R^{21a} in the general formula (a21) are the same, the larger the number of carbons of R^{21a} is, the lower a value of the HLB is. From the viewpoint of controlling a value of the HLB to further enhance detergency against stains attached to textile products, R^{21a} has 9 or more, preferably 10 or more and more preferably 11 or more, and preferably 18 or less, more preferably 16 or less, further preferably 15 or less and furthermore preferably 14 or less carbons.

R^{21a} is an aliphatic hydrocarbon group and preferably a group selected from an alkyl group and an alkenyl group from the viewpoint of further enhancing detergency against stains attached to textile products.

In the general formula (a21), A^{21a}O group is an alkyleneoxy group including an ethyleneoxy group with 2 or more and 4 or less carbons, preferably an alkyleneoxy group including an ethyleneoxy group with 2 or more and 3 or less carbons and more preferably an ethyleneoxy group. A^{21a}O group may be an alkyleneoxy group including an ethyleneoxy group and another alkyleneoxy group, for example, a propyleneoxy group. The another alkyleneoxy group is preferably a propyleneoxy group. When A^{21a}O group includes an ethyleneoxy group and a propyleneoxy group, the ethyleneoxy group and the propyleneoxy group may be bonded in block or bonded at random. An ethyleneoxy group makes a value of HLB higher than a propyleneoxy group.

In the general formula (a21), n2 is the number average number of added moles of A^{21a}O group and a number of 3 or more and 50 or less. If chemical structures other than n2 in the general formula (a21) are the same, the larger a number of n2 is, the higher a value of the HLB is, and the smaller a number of n2 is, the lower a value of the HLB is. n2 is 3 or more, preferably 4 or more, more preferably 5 or more and further preferably 6 or more, and 50 or less, preferably 40 or less, more preferably 30 or less, further preferably 20 or less, furthermore preferably 15 or less, furthermore preferably 12 or less, furthermore preferably 10 or less, furthermore preferably 8 or less and furthermore preferably 7 or less from the viewpoint of controlling a value of the HLB to further enhance detergency against stains attached to textile products.

Specific examples in the case of a nonionic surfactant having no polyoxyethylene group include one or more selected from a sucrose fatty acid ester, a glycerin fatty acid ester, a sorbitan fatty acid ester, an alkyl glycoside and a glyceryl monoether. The nonionic surfactant having no polyoxyethylene group has an HLB of preferably 9 or more and 15 or less according to Davies' method.

Specific examples of component (a22) of the present invention include one or more anionic surfactants selected from the following components (a221), (a222), (a223) and (a224):

component (a221): an alkyl or alkenyl sulfate ester salt;

component (a222): a polyoxyalkylene alkyl ether sulfate ester salt or a polyoxyalkylene alkenyl ether sulfate ester salt;

component (a223): an anionic surfactant having a sulfonate group; and

component (a224): a fatty acid with 10 or more and 20 or less carbons or a salt thereof (provided that component (a223) is excluded).

Specific examples and preferable modes of component (a221) are the same as those of the aforementioned component (a121) in the first mode of the present invention.

Specific examples and preferable modes of component (a222) are the same as those of the aforementioned component (a122) in the first mode of the present invention.

Specific examples and preferable modes of component (a223) are the same as those of the aforementioned component (a123) in the first mode of the present invention.

Specific examples and preferable modes of component (a224) are the same as those of the aforementioned component (a124) in the first mode of the present invention.

The salts of anionic surfactants of components (a221) to (a224) are preferably alkali metal salts, more preferably sodium salts or potassium salts, and further preferably sodium salts.

Component (a2) is preferably one or more selected from a nonionic surfactant including an ethyleneoxy group with an HLB of 9 or more and 15 or less and an anionic surfactant including any of a sulfonic acid group, a sulfate group and salts thereof, and more preferably one or more selected from a nonionic surfactant represented by the aforementioned general formula (a21) with an HLB of 9 or more and 15 or less, component (a221), component (a222) and component (a223) from the viewpoint of further enhancing detergency against stains attached to textile products.

As a surfactant other than the aforementioned components (a21) and (a22), an amphoteric surfactant or a cationic surfactant can be selected.

Examples of the amphoteric surfactant include, but are not particularly limited to, for example, an alkyl amine oxide having an alkyl group with 8 or more and 18 or less carbons, a carbobetaine, an amidobetaine, a sulfobetaine, an amidosulfobetaine, an imidazolinium betaine, a phosphobetaine and the like.

Examples of the cationic surfactant include, but are not particularly limited to, preferably a quaternary ammonium surfactant or a tertiary amine surfactant, and furthermore preferably a quaternary ammonium surfactant or a tertiary amine surfactant having one hydrocarbon group with 6 or more and 22 or less carbons which may be divided by an ether bond, an oxyalkylene group, an ester group or an amide group.

[Component (b)]

Component (b) of the present invention is an organic solvent having a hydroxyl group with a ClogP of −2.0 or more and less than 1.0. When component (b) is used with component (a2) at a particular ratio, it has the effect of reducing the spread of a stain attached to a textile product around the stain portion while maintaining the detergency of component (a2) against the stain. In the present invention, used as CLogP is a calculated value calculated using ChemProperty of ChemBioDraw Ultra ver. 14.0 from Perkin Elmer Inc. Note that the larger a value of ClogP is, the higher hydrophobicity is.

The ClogP of component (b) is preferably −1.6 or more and more preferably −1.3 or more from the viewpoint of further reducing the spread of a stain attached to a textile product around the stain portion while maintaining the detergency of component (a2) against the stain by using it with component (a2), and preferably 0.8 or less, more preferably 0.5 or less, further preferably 0.2 or less and furthermore preferably 0.1 or less from the same viewpoint.

In terms of further having the effect of reducing the spread of a stain attached to a textile product around the stain portion while maintaining the detergency of component (a2) against the stain by using component (b) with component (a2), component (b) is preferably one or more organic solvents having a hydroxyl group selected from the following components (b1) to (b3):

component (b1): an organic solvent having a hydroxyl group with a ClogP of −2.0 or more and less than 1.0, which is a monohydric alcohol with 2 or more and 6 or less carbons;

component (b2): an organic solvent having a hydroxyl group with a ClogP of −2.0 or more and less than 1.0, which is a dihydric or more and dodecahydric or less alcohol with 2 or more and 12 or less carbons; and component (b3): an organic solvent having a hydrocarbon group with 1 or more and 8 or less carbons, an ether group and a hydroxyl group with a ClogP of −2.0 or more and less than 1.0 (provided that an aromatic group is excluded from the hydrocarbon group).

Specific examples of components (b1) to (b3) are the same as those of the aforementioned components (b1) to (b3) in the first mode of the present invention.

Component (b) is preferably one or more selected from the aforementioned components (b1) and (b2) and more preferably one or more selected from ethanol, 2-propanol, ethylene glycol and propylene glycol from the viewpoint of being able to improve detergency against a stained center and reduce the spread of the stain from the center.

When the wiping detergent composition for textile products of the second mode of the present invention contains the aforementioned components (b1) and (b2), the mass ratio of the content of component (b1) to the content of component (b2), (b1)/(b2), is preferably 0.1 or more, more preferably 0.2 or more, further preferably 0.5 or more and furthermore preferably 1 or more, and preferably 20 or less, more preferably 15 or less, further preferably 10 or less, furthermore preferably 5 or less and furthermore preferably 3 or less from the viewpoint of a feeling during use.

In the present invention, when components (b1) and (b2) are used together, the proportion of the total of components (b1) and (b2) in component (b) is preferably 60 mass % or more and more preferably 80 mass % or more, and preferably 100 mass % or less and may be 100 mass %.

In the present invention, it is preferable to use ethanol as component (b1) from the viewpoint of a feeling during use, and it is preferable to use as component (b2) one or more selected from ethylene glycol, propylene glycol, glycerin, diethylene glycol and dipropylene glycol from the viewpoint of liquid stability.

[Component (c)]

The wiping detergent composition for textile products of the second mode of the present invention can contain as component (c) an organic solvent having a hydroxyl group with a ClogP of 1.0 or more and 2.2 or less. In the present invention, component (c) has the effect of reducing the spread of a stain around the stain portion by using it with component (b) at a particular ratio. Component (c) is preferably an organic solvent having a hydrocarbon group with 1 or more and 8 or less carbons, an ether group and a hydroxyl group with a ClogP of 1.0 or more and 2.2 or less in terms of having the effect of reducing the spread of a stain around the stain portion. Specific examples of component (c) are the same as those of the aforementioned component (c) in the first mode of the present invention.

The ClogP of component (c) is preferably 1.1 or more from the viewpoint of further reducing the spread of a stain around the stain portion by using it with component (b) at a particular ratio, and preferably 2 or less, more preferably 1.6 or less and further preferably 1.4 or less from the same viewpoint.

[Component (d)]

Component (d) of the present invention is a silicon compound. Component (d) can suppress a slimy feeling when the detergent composition is touched by hand. Compounds corresponding to component (a2), (b) or (c) are not included in component (d).

Component (d) is preferably one or more silicon compounds selected from (d1) a silicone compound (hereinafter also referred to as component (d1)) and (d2) an inorganic silicon compound (hereinafter also referred to as component (d2)).

Examples of component (d1) include one or more selected from a dialkyl polysiloxane (whose alkyl group has 1 or more and 18 or less carbons), a polyoxyalkylene-modified silicone (whose alkyleneoxy group has 2 or more and 3 or less carbons) and an amino-modified silicone (whose amino group is a group selected from a primary amino group, a secondary amino group and a tertiary amino group).

Examples of component (d2) include silicon dioxide.

The wiping detergent composition for textile products of the second mode of the present invention preferably contains both the aforementioned components (d1) and (d2) as component (d).

When the wiping detergent composition for textile products of the second mode of the present invention contains the aforementioned components (d1) and (d2), the mass ratio of the content of component (d1) to the content of component (d2), (d1)/(d2), is preferably 0.05 or more, more preferably 0.1 or more and further preferably 0.2 or more, and preferably 30 or less, more preferably 10 or less and further preferably 1 or less.

### [Composition and Others]

The wiping detergent composition for textile products of the second mode of the present invention contains component (a2) in an amount of 0.1 mass % or more, preferably 0.3 mass % or more, more preferably 0.4 mass % or more, more preferably 0.5 mass % or more, further preferably 1 mass % or more and furthermore preferably 1.5 mass % or more from the viewpoint of further enhancing detergency against stains attached to textile products, and 10 mass % or less, preferably 9 mass % or less, more preferably 8 mass % or less, further preferably 7 mass % or less, furthermore preferably 5 mass % or less and furthermore preferably 4.5 mass % or less from the viewpoint of the detergent composition applied to textile products being less sticky to the touch.

When the wiping detergent composition for textile products of the second mode of the present invention contains component (a21), the content of component (a21) in all surfactants contained in the composition is preferably 20 mass % or more, more preferably 40 mass % or more, further preferably 60 mass % or more, furthermore preferably 80 mass % or more and furthermore preferably 90 mass % or more, and preferably 100 mass % or less and may be 100 mass % from the viewpoint of detergency.

The wiping detergent composition for textile products of the second mode of the present invention contains component (b) in an amount of 0.1 mass % or more, preferably 0.2 mass % or more, more preferably 0.3 mass % or more, further preferably 0.5 mass % or more, furthermore preferably 1 mass % or more, furthermore preferably 1.5 mass % or more and furthermore preferably 2 mass % or more, and preferably 30 mass % or less, more preferably 20 mass % or less, further preferably 10 mass % or less, furthermore preferably 5 mass % or less, furthermore preferably 4 mass % or less and furthermore preferably 3 mass % or less from the viewpoint of attaining both detergency against a stain attached to a textile product and reduction in the spread of the stain around the stain portion.

In the wiping detergent composition for textile products of the second mode of the present invention, the mass ratio of the content of component (a2) to the content of component (b), (a2)/(b), is 0.60 or more and preferably 0.70 or more from the viewpoint of further enhancing detergency against stains attached to textile products, and 50 or less, preferably 30 or less, more preferably 10 or less, further preferably 7 or less, furthermore preferably 5 or less, furthermore preferably 3 or less, furthermore preferably 2 or less, furthermore preferably 1.5 or less and furthermore preferably 1.0 or less from the viewpoint of reducing the spread of a stain around the stain portion attached to a textile product.

The wiping detergent composition for textile products of the second mode of the present invention contains component (c) in an amount of preferably 5 mass % or less, more preferably 4 mass % or less, further preferably 3 mass % or less, furthermore preferably 2 mass % or less and furthermore preferably 1 mass % or less from the viewpoint of being able to suppress a slimy feeling when the detergent composition is touched by hand, and preferably 0.1 mass % or more and more preferably 0.2 mass % or more from the viewpoint of further enhancing detergency.

In the wiping detergent composition for textile products of the second mode of the present invention, the mass ratio of the content of component (b) to the content of component (c), (b)/(c), is preferably 1 or more, more preferably 1.5 or more, further preferably 2 or more, furthermore preferably 2.5 or more, furthermore preferably 3 or more, furthermore preferably 3.5 or more, furthermore preferably 4 or more, furthermore preferably 4.5 or more and furthermore preferably 5 or more from the viewpoint of being able to suppress a slimy feeling when the detergent composition is touched by hand, and preferably 50 or less, more preferably 40 or less, further preferably 30 or less, furthermore preferably 20 or less, furthermore preferably 10 or less and furthermore preferably 8 or less from the same viewpoint.

The wiping detergent composition for textile products of the second mode of the present invention contains component (d) in an amount of preferably 0.001 mass % or more, more preferably 0.003 mass % or more, further preferably 0.005 mass % or more, furthermore preferably 0.007 mass % or more and furthermore preferably 0.01 mass % or more, and preferably 1 mass % or less and more preferably 0.5 mass % or less from the viewpoint of being able to further reduce the slimy feeling.

In the wiping detergent composition for textile products of the second mode of the present invention, the mass ratio between the content of component (a2) and the content of component (d), (d)/(a2), is preferably 0.001 or more, more preferably 0.005 or more, further preferably 0.01 or more and furthermore preferably 0.03 or more from the viewpoint of being able to suppress a slimy feeling when the detergent composition is touched by hand, and preferably 1 or less, more preferably 0.5 or less, further preferably 0.1 or less and furthermore preferably 0.05 or less from the same viewpoint.

The wiping detergent composition for textile products of the second mode of the present invention can contain the following components (e1) to (e3) as optional components:

component (e1): a hydroxylamine compound including an amino group and a hydroxyl group with 1 or more and 8 or less carbons;

component (e2): a carboxylic acid with 1 or more and 9 or less carbons or a salt thereof; and

component (e3): a fragrance compound, an antioxidant, a preservative, a dye or a pH adjuster (provided that the aforementioned components (a2), (b), (c), (d) and (e1) to (e2) are excluded).

The amino group in component (e1) is preferably one or more amino groups selected from a primary amino group and a secondary amino group. Specific examples of component (e1) include one or more compounds selected from monoethanolamine, mono lower alkyl (with 1 or more and 3 or less carbons) amino monoethanolamine, mono lower alkyl (with 1 or more and 3 or less carbons) amino diethanolamine, di lower alkyl (with 1 or more and 3 or less carbons) amino monoethanolamine, triethanolamine and tris(hydroxymethyl)aminomethane. Component (e1) may be contained as an ammonium ion depending on pH in the detergent composition of the second mode of the present invention. The wiping detergent composition for textile products of the second mode of the present invention can contain component (e1) in the range of 0.1 mass % or more and 2 mass % or less.

Specific examples of component (e2) include one or more compounds selected from formic acid, glycolic acid, lactic acid, citric acid, maleic acid, fumaric acid, salicylic acid, benzoic acid and salts thereof. Examples of the salts include alkyl metal salts such as sodium salts or the like and alkaline earth metal salts such as magnesium salts, calcium salts or the like. The wiping detergent composition for textile products of the second mode of the present invention can contain component (e2) in the range of 0.1 mass % or more and 3 mass % or less.

The wiping detergent composition for textile products of the second mode of the present invention contains water. As the water, ion exchange water, distilled water, sterilized purified water, tap water or water containing 0.1 mg/kg or more and 5 mg/kg or less of hypochlorite such as sodium hypochlorite or the like can be used.

The wiping detergent composition for textile products of the second mode of the present invention contains water in an amount of preferably 70 mass % or more, more preferably 75 mass % or more and further preferably 80 mass % or more, and preferably 99 mass % or less, more preferably 98 mass % or less and further preferably 97 mass % or less.

The pH of the wiping detergent composition for textile products of the second mode of the present invention at 25° C. is preferably 6.0 or more, more preferably 6.5 or more, further preferably 7.0 or more and furthermore preferably 7.5 or more, and preferably 9.0 or less and more preferably 8.0 or less from the viewpoints of washing performance and a sensation on hands and skin. The pH of the detergent composition of the present invention can be measured by a method described in Examples using a glass electrode.

The following descriptions are common to the first and second modes of the present invention.

### <Method for Removing Stain Attached to Textile Product>

A method for removing a stain attached to a textile product of the present invention is a method including impregnating the stained portion of the textile product with the wiping detergent composition for textile products of the present invention, and thereafter wiping the stained portion with a base material, or a method including impregnating a base material with the wiping detergent composition for textile products of the present invention, and thereafter wiping the stained portion of the textile product with the impregnated base material.

A stain attached to a textile product to which the present invention is directed is, for example, a spot stain derived from food, blood or cosmetics, and it is more preferably directed to a spot stain derived from food. All that are needed to wipe such a spot stain attached to a textile product with a base material are pressing the base material against the spot stain attached to the textile product and transferring the spot stain to the base material by applying external force, which may be any of scrubbing, rubbing or beating, in such a range as not to damage the textile product.

While examples of the base material used in the method for removing a stain attached to a textile product of the present invention include a nonwoven fabric, a woven fabric, paper, a sponge or the like processed into a sheet form, it is preferable to use a nonwoven fabric processed into a sheet form from the viewpoint of ease of use.

A fiber constituting the nonwoven fabric is preferably composed of one or more fibers selected from a hydrophilic fiber and a hydrophobic fiber.

In the present invention, a hydrophilic fiber refers to a fiber with a moisture content of more than 5% in the normal state (20° C., 65% RH). Note that the moisture content in the normal state is measured by methods prescribed in JISL 1013 and JISL 1015. In addition, a hydrophobic fiber refers to a fiber with a moisture content of 5 mass % or less in the normal state (20° C., 65% RH).

Examples of a hydrophobic chemical fiber include, for example, polyamide fibers (nylon and the like), polyester fibers (polyester and the like), polyacrylonitrile fibers (acrylic and the like), polyvinyl alcohol fibers (vinylon and the like), polyvinyl chloride fibers (polyvinyl chloride and the like), polyvinylidene chloride fibers (vinylidene and the like), polyolefin fibers (polyethylene, polypropylene and the like), polyurethane fibers (polyurethane and the like) and polyvinyl chloride/polyvinyl alcohol copolymer fibers (polyclar and the like), etc., and one or two or more of them can be used.

Examples of a hydrophilic fiber include seed hair fibers (cotton, cotton, kapok and the like), bast fibers (hemp, flax, ramie, cannabis, jute and the like), vein fibers (manila hemp, sisal hemp and the like), palm fibers, juncus, straw, animal hair fibers (wool, mohair, cashmere, camel hair, alpaca, vicuna, angora and the like), silk fibers (domestic silk and wild silk), feathers and cellulose fibers (rayon, polynosic, cupro, acetate and the like), etc., and one or two or more of them can be used.

The nonwoven fabric used for the present invention preferably includes a hydrophilic fiber. The nonwoven fabric used for the present invention is favorably a nonwoven fabric including a hydrophilic fiber in an amount of preferably 50 mass % or more, more preferably 60 mass % or more, further preferably 70 mass % or more and furthermore preferably 75 mass % or more, and preferably 100 mass % or less, more preferably 90 mass % or less and further preferably 85 mass % or less from the viewpoint of further enhancing detergency.

A value of the bending stiffness (B value) of the nonwoven fabric used for the present invention is preferably 0.10 gf·cm²/cm or more, more preferably 0.12 gf·cm²/cm or more, further preferably 0.13 gf·cm²/cm or more, furthermore preferably 0.15 gf·cm²/cm or more and furthermore preferably 0.2 gf·cm²/cm or more, and preferably 3 gf·cm²/cm or less, more preferably 2 gf·cm²/cm or less and further preferably 1 gf·cm²/cm or less from the viewpoint of further enhancing detergency. In the present invention, a bending stiffness value can be measured by the following method. A nonwoven fabric cut into a size of 20 cm×20 cm is subjected to a bending test at a constant speed (a strain rate of 0.5 cm⁻¹/sec.) in the range of K=±2.5 cm⁻¹ in curvature using a pure bending tester (e.g., KES-FB2 (manufactured by KATO TECH CO., LTD.)), and a B value of the bending stiffness (gf·cm²/cm) per unit length is calculated. The bending test is conducted at three locations in each of the longitudinal and transverse directions; the respective average values in the longitudinal and transverse directions are calculated; and a larger value in the longitudinal or transverse direction is taken as a value of the bending stiffness (B value).

The basis weight of the nonwoven fabric used in the present invention is preferably 10 g/m² or more and more preferably 20 g/m² or more, and preferably 100 g/m² or less, more preferably 80 g/m² or less and further preferably 60 g/m² or less from the viewpoint of reducing the spread of a stain around the stain portion attached to a textile product.

### <Wiping Washing Sheet for Textile Products>

When the method for removing a stain attached to a textile product of the present invention includes impregnating a base material with the wiping detergent composition for textile products of the present invention, and thereafter wiping the stained portion of the textile product with the impregnated base material, it is preferable to wipe the stained portion with a washing sheet prepared by impregnating a base material or preferably a nonwoven fabric with the detergent composition.

That is, a wiping washing sheet for textile products of the present invention is a washing sheet including the detergent composition of the present invention and a base material or preferably a nonwoven fabric. The washing sheet of the present invention is suitable as a washing sheet for wiping stains attached to textile products. As the nonwoven fabric, any of those in the aforementioned modes can be used.

When a base material or preferably a nonwoven fabric is impregnated with the detergent composition, the percentage of the mass of the detergent composition to the mass of the base material or preferably a nonwoven fabric (impregnation rate (mass %)) is preferably 100 mass % or more, more preferably 200 mass % or more, further preferably 250 mass % or more, furthermore preferably 300 mass % or more and furthermore preferably 350 mass % or more from the viewpoint of further enhancing detergency, and preferably 700 mass % or less, more preferably 600 mass % or less, further preferably 550 mass % or less and furthermore preferably 500 mass % or less from the viewpoint of further reducing a residue on the periphery of a stain attached to a textile product. The impregnation rate is calculated by the following formula:

Impregnation rate (mass %)=((mass of base material impregnated with detergent composition)/(mass of dried base material)−1)×100

The wiping detergent composition for textile products and the wiping washing sheet for textile products using the same of the present invention are capable of reducing the degree of soiling of a portion of a textile product to which a stain derived from food or the like is attached by wiping the stained portion with the washing sheet of the present invention. In addition, the washing sheet using the wiping detergent composition for textile products of the second mode of the present invention is capable of reducing a slimy feeling when the detergent composition is touched by hand through the washing sheet impregnated therewith during the wipe of the stain.

With respect to the aforementioned embodiments, the present invention further discloses the following wiping detergent compositions for textile products.

<1x>

A wiping detergent composition for textile products containing the following component (a1) in an amount of 0.3 mass % or more and 10 mass % or less, the following component (b) in an amount of 0.1 mass % or more, and water, wherein the mass ratio of the content of component (a1) to the content of component (b), (a1)/(b), is 0.6 or more and 50 or less,

component (a1): one or more surfactants selected from a nonionic surfactant with an HLB of 9 or more and 16.0 or less and an anionic surfactant, and

component (b): an organic solvent having a hydroxyl group with a ClogP of −2.0 or more and less than 1.0.

<2x>

The wiping detergent composition for textile products according to <1x>, wherein component (a1) is (a11) a nonionic surfactant with an HLB of 9 or more and 16.0 or less (hereinafter referred to as component (a11)).

<3x>

The wiping detergent composition for textile products according to <2x>, wherein component (a11) is a nonionic surfactant represented by the following general formula (a11) with an HLB of 9 or more, preferably 9.5 or more, more preferably 10 or more, furthermore preferably 10.5 or more and furthermore preferably 11 or more, and 16.0 or less, preferably 15.0 or less, more preferably 14.5 or less, further preferably 14 or less, furthermore preferably 13 or less and furthermore preferably 12 or less,

R^{11a}(CO)ₘ₁O-(A^{11a}O)ₙ₁—R^{12a} (a11)

wherein R^{11a} is an aliphatic hydrocarbon group with 9 or more and 18 or less carbons, and R^{12a} is a hydrogen atom or a methyl group; CO is a carbonyl group, and m1 is a number of 0 or 1; A^{11a}O group is an alkyleneoxy group including an ethyleneoxy group with 2 or more and 4 or less carbons; and n1 is an average number of added moles and a number of 3 or more and 50 or less.

<4x>

The wiping detergent composition for textile products according to <3x>, wherein R^{11a} in the general formula (a11) is a group selected from an aliphatic hydrocarbon group and preferably an alkyl group and an alkenyl group with 9 or more, preferably 10 or more and more preferably 11 or more, and 18 or less, more preferably 16 or less, further preferably 15 or less and furthermore preferably 14 or less carbons.

<5x>

The wiping detergent composition for textile products according to <1x>, wherein component (a1) is (a12) an anionic surfactant (hereinafter referred to as component (a12)).

<6x>

The wiping detergent composition for textile products according to <5x>, wherein component (a12) is one or more anionic surfactants selected from the following components (a121), (a122), (a123) and (a124):

component (a121): an alkyl or alkenyl sulfate ester salt;

component (a122): a polyoxyalkylene alkyl ether sulfate ester salt or a polyoxyalkylene alkenyl ether sulfate ester salt;

component (a123): an anionic surfactant having a sulfonate group; and

component (a124): a fatty acid with 10 or more and 20 or less carbons or a salt thereof (provided that component (a123) is excluded).

<7x>

The wiping detergent composition for textile products according to any of <1x> to <6x>, wherein the ClogP of component (b) is preferably −1.6 or more and more preferably −1.3 or more, and preferably 0.8 or less, more preferably 0.5 or less, further preferably 0.2 or less and furthermore preferably 0.1 or less.

<8x>

The wiping detergent composition for textile products according to any of <1x> to <7x>, wherein component (b) is one or more selected from ethanol, 2-propanol, ethylene glycol and propylene glycol.

<9x>

The wiping detergent composition for textile products according to any of <1x> to <8x>, wherein the content of component (a1) in all surfactants contained in the composition is preferably 20 mass % or more, more preferably 40 mass % or more, further preferably 60 mass % or more, furthermore preferably 80 mass % or more and furthermore preferably 90 mass % or more, and preferably 100 mass % or less.

<10x>

The wiping detergent composition for textile products according to any of <1x> to <9x>, wherein the composition contains component (b) in an amount of preferably 0.2 mass % or more, more preferably 0.3 mass % or more and further preferably 0.5 mass % or more, and preferably 15 mass % or less, more preferably 10 mass % or less, further preferably 5 mass % or less, furthermore preferably 4 mass % or less, furthermore preferably 3 mass % or less, furthermore preferably 2 mass % or less and furthermore preferably 1.5 mass % or less.

<11x>

The wiping detergent composition for textile products according to any of <1x> to <10x>, wherein the mass ratio of the content of component (a1) to the content of component (b), (a1)/(b), is preferably 0.70 or more, more preferably 0.80 or more, further preferably 1.0 or more, furthermore preferably 2.0 or more and furthermore preferably 3.0 or more, and preferably 30 or less, more preferably 10 or less, further preferably 7 or less, furthermore preferably 5 or less and furthermore preferably 4 or less.

<12x>

The wiping detergent composition for textile products according to any of <1x> to <11x>, wherein the composition further contains an organic solvent having a hydroxyl group with a ClogP of 1.0 or more and 2.2 or less [hereinafter referred to as component (c)] in an amount of 0.1 mass % or more and 5 mass % or less.

<13x>

The wiping detergent composition for textile products according to <12x>, wherein the ClogP of component (c) is preferably 1.1 or more, and preferably 2 or less, more preferably 1.6 or less and further preferably 1.4 or less.

<14x>

The wiping detergent composition for textile products according to <12x> or <13x>, wherein the composition contains component (c) in an amount of preferably 0.1 mass % or more and further preferably 0.2 mass % or more, and preferably 5 mass % or less, more preferably 4 mass % or less, further preferably 3 mass % or less, furthermore preferably 2 mass % or less and furthermore preferably 1 mass % or less.

<15x>

The wiping detergent composition for textile products according to any of <12x> to <14x>, wherein the mass ratio of the content of component (b) to the content of component (c), (b)/(c), is preferably 1 or more, more preferably 1.5 or more and further preferably 2 or more, and preferably 50 or less, more preferably 40 or less, further preferably 30 or less, furthermore preferably 20 or less, furthermore preferably 10 or less, furthermore preferably 8 or less, furthermore preferably 6 or less and furthermore preferably 4 or less.

<1y>

A wiping detergent composition for textile products containing the following component (a2) in an amount of 0.1 mass % or more and 10 mass % or less, the following component (b) in an amount of 0.1 mass % or more, the following component (d), and water, wherein the mass ratio of the content of component (a2) to the content of component (b), (a2)/(b), is 0.6 or more and 50 or less,

component (a2): a surfactant,

component (b): an organic solvent having a hydroxyl group with a ClogP of −2.0 or more and less than 1.0, and

component (d): a silicon compound.

<2y>

The wiping detergent composition for textile products according to <1y>, wherein component (a2) is (a21) a nonionic surfactant (hereinafter referred to as component (a21)).

<3y>

The wiping detergent composition for textile products according to <2y>, wherein component (a21) is a nonionic surfactant represented by the following general formula (a21) with an HLB of 9 or more, preferably 9.5 or more, more preferably 10 or more, furthermore preferably 10.5 or more and furthermore preferably 11 or more, and 15 or less, preferably 14.5 or less, more preferably 14 or less, furthermore preferably 13 or less and furthermore preferably 12 or less,

R^{21a}(CO)ₘ₂O-(A^{21a}O)ₙ₂—R^{22a} (a1)

wherein R^{21a} is an aliphatic hydrocarbon group with 9 or more and 18 or less carbons, and R^{22a} is a hydrogen atom or a methyl group; CO is a carbonyl group, and m2 is a number of 0 or 1; A^{21a}O group is an alkyleneoxy group including an ethyleneoxy group with 2 or more and 4 or less carbons; and n2 is an average number of added moles and a number of 3 or more and 50 or less.

<4y>

The wiping detergent composition for textile products according to <3y>, wherein R^{21a} in the general formula (a21) is a group selected from an aliphatic hydrocarbon group and preferably an alkyl group and an alkenyl group with 9 or more, preferably 10 or more and more preferably 11 or more, and 18 or less, more preferably 16 or less, further preferably 15 or less and furthermore preferably 14 or less carbons.

<5y>

The wiping detergent composition for textile products according to any of <2y> to <4y>, wherein the content of component (a21) in all surfactants contained in the composition is preferably 20 mass % or more, more preferably 40 mass % or more, further preferably 60 mass % or more, furthermore preferably 80 mass % or more and furthermore preferably 90 mass % or more, and preferably 100 mass % or less.

<6y>

The wiping detergent composition for textile products according to <1y>, wherein component (a2) is (a22) an anionic surfactant (hereinafter referred to as component (a22)).

<7y>

The wiping detergent composition for textile products according to <6y>, wherein component (a22) is one or more anionic surfactants selected from the following components (a221), (a222), (a223) and (a224):

component (a221): an alkyl or alkenyl sulfate ester salt;

component (a222): a polyoxyalkylene alkyl ether sulfate ester salt or a polyoxyalkylene alkenyl ether sulfate ester salt;

component (a223): an anionic surfactant having a sulfonate group; and

component (a224): a fatty acid with 10 or more and 20 or less carbons or a salt thereof (provided that component (a223) is excluded).

<8y>

The wiping detergent composition for textile products according to any of <1y> to <7y>, wherein the composition contains component (a2) in an amount of preferably 0.3 mass % or more, more preferably 0.4 mass % or more, more preferably 0.5 mass % or more, further preferably 1 mass % or more and furthermore preferably 1.5 mass % or more, and preferably 9 mass % or less, more preferably 8 mass % or less, further preferably 7 mass % or less, furthermore preferably 5 mass % or less and furthermore preferably 4.5 mass % or less.

<9y>

The wiping detergent composition for textile products according to any of <1y> to <8y>, wherein component (b) is one or more selected from ethanol, 2-propanol, ethylene glycol and propylene glycol.

<10y>

The wiping detergent composition for textile products according to any of <1y> to <9y>, wherein the mass ratio of the content of component (a2) to the content of component (b), (a2)/(b), is preferably 0.70 or more, and preferably 30 or less, more preferably 10 or less, further preferably 7 or less, furthermore preferably 5 or less, furthermore preferably 3 or less, furthermore preferably 2 or less, furthermore preferably 1.5 or less and furthermore preferably 1.0 or less.

<11y>

The wiping detergent composition for textile products according to any of <1y> to <10y>, wherein the composition further contains an organic solvent having a hydroxyl group with a ClogP of 1.0 or more and 2.2 or less [hereinafter referred to as component (c)] in an amount of 0.1 mass % or more and 5 mass % or less.

<12y>

The wiping detergent composition for textile products according to <11y>, wherein the mass ratio of the content of component (b) to the content of component (c), (b)/(c), is preferably 1 or more, more preferably 1.5 or more, further preferably 2 or more, furthermore preferably 2.5 or more, furthermore preferably 3 or more, furthermore preferably 3.5 or more, furthermore preferably 4 or more, furthermore preferably 4.5 or more and furthermore preferably 5 or more, and preferably 50 or less, more preferably 40 or less, further preferably 30 or less, furthermore preferably 20 or less, furthermore preferably 10 or less and furthermore preferably 8 or less.

<13y>

The wiping detergent composition for textile products according to any of <1y> to <12y>, wherein the composition contains component (d) in an amount of preferably 0.001 mass % or more, more preferably 0.003 mass % or more, further preferably 0.005 mass % or more, furthermore preferably 0.007 mass % or more and furthermore preferably 0.01 mass % or more, and preferably 1 mass % or less and more preferably 0.5 mass % or less.

### EXAMPLES

### Examination Example 1

Detergent compositions were formulated with the following components.

<Component (a1)>
(a1-1): polyoxyethylene (5) lauryl ether (average number of added moles of oxyethylene group: 5, HLB: 10.8, manufactured by Kao Corporation)
(a1-2): polyoxyethylene (6) lauryl ether (average number of added moles of oxyethylene group: 6, HLB: 11.7, manufactured by Kao Corporation)
(a1-3): polyoxyethylene (14) lauryl ether (average number of added moles of oxyethylene group: 14.1, HLB: 15.4, manufactured by Kao Corporation)
(a1-4): polyoxyethylene (12) lauryl ether (average number of added moles of oxyethylene group: 12, HLB: 14.8, manufactured by Kao Corporation)
(a1-5): sodium alkylbenzene sulfonate (alkyl group: lauryl group, manufactured by KANTO CHEMICAL CO., INC.)
(a1-6): sodium alkyl sulfate (alkyl group: lauryl group, manufactured by Wako Pure Chemical Industries, Ltd.)
(a1-7): sodium polyoxyethylene (2) alkyl ether sulfate (alkyl group: lauryl group, average number of added moles of oxyethylene group: 2, manufactured by Kao Corporation)
<Component (a1′): Comparative Compound of Component (a1)>
(a1′-1): polyoxyethylene (3) lauryl ether (average number of added moles of oxyethylene group: 3, HLB: 8.3, manufactured by Kao Corporation)
(a1′-2): polyoxyethylene (21) lauryl ether (average number of added moles of oxyethylene group: 21, HLB: 16.6, manufactured by Kao Corporation)
(a1′-3): polyoxyethylene (19) alkyl ether (average number of added moles of oxyethylene group: 19, HLB: 16.4, manufactured by Kao Corporation)
(a1′-4): lauryl trimethyl ammonium chloride
<Component (b)>

The values inside the parentheses are calculated values of ClogP calculated using ChemProperty of ChemBioDraw Ultra ver. 14.0 from Perkin Elmer Inc.

(b1-1): ethanol (−0.24)
(b2-1): propylene glycol (−1.1)
<Component (c)>

The value inside the parentheses is a calculated value of ClogP calculated using ChemProperty of ChemBioDraw Ultra ver. 14.0 from Perkin Elmer Inc.

(c-1): 2-phenoxyethanol (1.2)

### <Optional Components>

(e-1): tris(hydroxymethyl)aminomethane
(e-2): citric acid
(e-3): caustic soda (1 mass % aqueous solution, used as a pH adjuster)

### <Preparation of Wiping Detergent Compositions for Textile Products>

Wiping detergent compositions for textile products listed in Tables 1 and 2 were prepared as follows using the aforementioned formulation components. Component (a1), component (a1′), component (b), component (c) and optional components other than the pH adjuster were put into a 100 mL glass beaker, to which ion exchange water (50° C.) in an amount of 90 mass % of a required amount was added and into which a stirrer piece (made of Teflon®, 3 cm long) was put, and which was sealed with Saran Wrap®, and the contents were stirred for 10 minutes. After stirred for 10 minutes, the contents were transferred to a water bath filled with water at 5° C. and cooled while stirred until the temperature of the contents reached 25° C. Using a pH meter equipped with a glass pH electrode, the pH was adjusted to a predetermined level by adding the pH adjuster. Ion exchange water was added to make the contents 100 mass %. The pH of the final compositions was measured and listed in Tables 1 and 2. A method for measuring pH is as follows. Note that, in Tables 1 and 2, the content of each formulation component is the amount of an active component.

<Method for Measuring pH>

A composite electrode for pH measurement (manufactured by HORIBA, Ltd., glass slide-in sleeve type) was connected to a pH meter (pH/ion meter F-23 manufactured by HORIBA, Ltd.), and the power was turned on. A saturated potassium chloride aqueous solution (3.33 mole/L) was used as an internal solution of the pH electrode. Next, a pH 4.01 standard solution (phthalate standard solution), a pH 6.86 standard solution (neutral phosphate standard solution) and a pH 9.18 standard solution (borate standard solution) were each filled into 100 mL beakers, which were immersed in a thermostatic bath at 25° C. for 30 minutes. Calibration operation was performed in the order of pH 6.86, pH 9.18 and pH 4.01 by immersing the electrode for pH measurement in each of the standard solutions adjusted to the constant temperature for 3 minutes. A sample to be measured was adjusted to 25° C.; the electrode of the pH meter was immersed in the sample; and the pH was measured 1 minute later.

### <Washing Test>

### (1) Pre-Washing of Test Cloth

Commercially available TC broadcloth (cotton/polyester ratio=65/35, purchased from Senshoku Shizai Kabushikikaisha Tanigashira Shoten) was cut into sheets each with a size of 1 m×1 m, which were prepared as many as a number equivalent to a mass of about 1.5 kg. EMULGEN 108 (polyoxyethylene alkyl ether, manufactured by Kao Corporation) was dissolved in city water in an amount of 500 mg/kg and washing operation was performed three times in an automatic washing machine (manufactured by TOSHIBA CORPORATION, model number: AW-8D3M). The bath ratio was 20 and the water temperature was 15° C. After that, they were rinsed under running water until no bubbles appeared, dried, and then used.

### (2) Preparation of Curry-Soiled Cloth

The pre-washed sheets of TC broadcloth were cut into 6 cm×6 cm pieces, three of which were stacked on top of one another, coated with 50 μl of curry (Soot Thai Red Curry, purchased at Kaldi) heated in a thermostatic bath at 50° C. in the shape of a circle with a diameter of 1 cm, and then, left to stand for 20 minutes under the circumstance at 23° C. and 50% RH. The top one of the three stacked pieces was used as a piece of curry-soiled cloth.

### (3) Method of Washing Test

A sheet-like spunlace nonwoven fabric (rayon/polypropylene/polyester ratio=80/10/10, basis weight 60 g/m², 150 mm×100 mm) was impregnated with each of the detergent compositions listed in Tables 1 and 2 at an impregnation rate of 350 mass % relative to the mass of the nonwoven fabric to prepare a wet nonwoven fabric. A wiping test was conducted such that the stained surface of the piece of curry-soiled cloth was wiped with the wet nonwoven fabric 50 times. Note that, in the wiping test with the wet nonwoven fabric, washing operation was performed such that, every 10 times the stain attached to the textile product was wiped with one surface of the wet nonwoven fabric making contact therewith, the surface was changed to the other, with which the stain was wiped. After wiped, the piece of curry-soiled cloth was left to stand for 12 hours under the circumstance at 25° C. and 60% RH.

### (4) Method for Evaluating Detergency

### (4-1) Method for Evaluating Stain Removal Rate

The reflectance of the stained surface of the piece of curry-soiled cloth after left to stand was measured (with NF777 manufactured by NIPPON DENSHOKU INDUSTRIES CO., LTD., range to be measured: a circle with a diameter of 5 mm at the center of the stain). A stain removal rate was calculated by the following formula, and the average value from measurements of three different pieces of curry-soiled cloth is listed in Tables 1 and 2. Note that reflectance (Z value) before wiping is Za, a Z value after wiping is Zb, and a Z value of white cloth is Zo.

Stain removal rate (%)=(Zb−Za)/(Zo−Za)×100

The higher a value of the stain removal rate is, the more excellent detergency is, and those with a stain removal rate of 70% or more are preferable.

### (4-2) Method for Evaluating Stain Spreading Rate

Before and after the washing test in (3), the piece of cloth was subjected to image analysis using a scanner (manufactured by SEIKO EPSON CORPORATION, model type: GT-X820). The area of a range in which the stain was attached was determined and compared with the area of the stain before the washing test, and a stain spreading rate was calculated by the following formula. The average value of the stain spreading rates of three different pieces of curry-soiled cloth is listed in Tables 1 and 2.

Stain spreading rate (%)=(area of stain after washing)/(area of initial stain)×100

The smaller a value of the stain spreading rate is, the less a stain is spread out by wiping, and those with a stain spreading rate of 150% or less are preferable.

TABLE 1

| | | | | Examination example | | | | | | | |
|---|---|---|---|---|---|---|---|---|---|---|---|
| | | | | 1-1 | 1-2 | 1-3 | 1-4 | 1-5 | 1-6 | 1-7 | 1-8 |
| Wiping | Formulation | Component (a1) | (a1-1) | 0.5 | 1 | 2 | 4 | 3 | 4 | 5 | 10 |
| detergent | composition | Component (b) | (b2-1) | 1 | 1 | 1 | 0.35 | 1 | 1 | 1 | 1 |
| composition | (mass %) | | (b1-1) | | 2 | 2 | 0.65 | 2 | 2 | 2 | 2 |
| for textile | | Component (c) | (c-1) | 0.5 | 0.5 | 0.5 | 0.5 | 0.5 | 0.5 | 0.5 | 0.5 |
| products | | Optional | (e-1) | 0.4 | 0.4 | 0.4 | 0.4 | 0.4 | 0.4 | 0.4 | 0.4 |
| | | component | (e-2) | 0.3 | 0.3 | 0.3 | 0.3 | 0.3 | 0.3 | 0.3 | 0.3 |
| | | | (e-3) | Amounts required for adjusting pH to the followings | | | | | | | |
| | | Ion exchange water | | Balance | Balance | Balance | Balance | Balance | Balance | Balance | Balance |
| | | Total | | 100 | 100 | 100 | 100 | 100 | 100 | 100 | 100 |
| | pH (25° C.) | | | 7.5 | 7.8 | 7.8 | 7.8 | 7.8 | 7.8 | 7.8 | 7.8 |
| | (a1)/(b) (mass ratio) | | | 0.5 | 0.33 | 0.67 | 4.0 | 1.0 | 1.3 | 1.7 | 3.3 |
| | (b)/(c) (mass ratio) | | | 2 | 6 | 6 | 2 | 6 | 6 | 6 | 6 |
| Evaluation | | Stain removal rate (%) | | 67 | 68 | 77 | 87 | 82 | 89 | 90 | 93 |
| result | | Stain spreading rate (%) | | 130 | 134 | 133 | 124 | 132 | 136 | 137 | 145 |
| | | | | Examination example | | | | | | | |
| | | | | 1-9 | 1-10 | 1-11 | 1-12 | 1-13 | 1-14 | 1-15 | 1-16 |
| Wiping | Formulation | Component (a1) | (a1-1) | | 0.1 | 2 | 0.5 | 2 | 2 | 5 | 10 |
| detergent | composition | Component (b) | (b2-1) | 1 | 0.1 | 3 | 1.5 | 1 | 0.1 | 0.1 | 10 |
| composition | (mass %) | | (b1-1) | 2 | | 6 | 3 | 2 | 0.1 | | 5 |
| for textile | | Component (c) | (c-1) | 0.5 | 0.5 | 0.5 | 0.5 | 5 | 0.2 | 0.1 | 0.2 |
| products | | Optional | (e-1) | 0.4 | 0.4 | 0.4 | 0.4 | 0.4 | 0.4 | 0.4 | 0.4 |
| | | component | (e-2) | 0.3 | 0.3 | 0.3 | 0.3 | 0.3 | 0.3 | 0.3 | 0.3 |

| | |
|---|---|
| (e-3) | Amounts required for adjusting pH to the followings |

| | | | | | | | | |
|---|---|---|---|---|---|---|---|---|
| Ion exchange water | Balance | Balance | Balance | Balance | Balance | Balance | Balance | Balance |
| Total | 100 | 100 | 100 | 100 | 100 | 100 | 100 | 100 |

| | | | | | | | | |
|---|---|---|---|---|---|---|---|---|
| pH (25° C.) | 7.8 | 7.8 | 7.8 | 7.8 | 7.8 | 7.8 | 7.8 | 7.8 |
| (a1)/(b) (mass ratio) | 0 | 1.0 | 0.22 | 0.11 | 0.67 | 10 | 50 | 0.67 |
| (b)/(c) (mass ratio) | 6 | 0.2 | 18 | 9 | 0.6 | 1 | 1 | 75 |

| | | | | | | | | | |
|---|---|---|---|---|---|---|---|---|---|
| Evaluation | Stain removal rate (%) | 35 | 40 | 70 | 62 | 72 | 78 | 85 | 90 |
| result | Stain spreading rate (%) | 120 | 115 | 177 | 147 | 150 | 128 | 130 | 148 |

TABLE 2

| | | | | Examination example | | | | | | | |
|---|---|---|---|---|---|---|---|---|---|---|---|
| | | | | 1-17 | 1-18 | 1-19 | 1-20 | 1-21 | 1-22 | 1-23 | 1-24 |
| Wiping | Formulation | Component (a1) | (a1-1) | 1 | | | | 4 | | | |
| detergent | composition | | (a1-2) | | 1 | | | | 4 | | |
| composition | (mass %) | | (a1-3) | | | 1 | | | | 4 | |
| for textile | | | (a1-4) | | | | 1 | | | | 4 |
| products | | | (a1-5) | | | | | | | | |
| | | | (a1-6) | | | | | | | | |
| | | | (a1-7) | | | | | | | | |
| | | Component (a1′) | (a1′-1) | | | | | | | | |
| | | | (a1′-2) | | | | | | | | |
| | | | (a1′-3) | | | | | | | | |
| | | | (a1′-4) | | | | | | | | |
| | | Component (b) | (b1-1) | | | | | | | | |
| | | Component (c) | (c-1) | 0.5 | 0.5 | 0.5 | 0.5 | 0.5 | 0.5 | 0.5 | 0.5 |
| | | Optional | (e-1) | 0.4 | 0.4 | 0.4 | 0.4 | 0.4 | 0.4 | 0.4 | 0.4 |
| | | component | (e-2) | 0.3 | 0.3 | 0.3 | 0.3 | 0.3 | 0.3 | 0.3 | 0.3 |

| | |
|---|---|
| (e-3) | Amounts required tor adjusting pH to the followings |

| | | | | | | | | |
|---|---|---|---|---|---|---|---|---|
| Ton exchange water | Balance | Balance | Balance | Balance | Balance | Balance | Balance | Balance |
| Total | 100 | 100 | 100 | 100 | 100 | 100 | 100 | 100 |

| | | | | | | | | |
|---|---|---|---|---|---|---|---|---|
| pH (25° C.) | 7.8 | 7.8 | 7.8 | 7.8 | 7.8 | 7.8 | 7.8 | 7.8 |
| (a1)/(b) (mass ratio)* | 1.0 | 1.0 | 1.0 | 1.0 | 4.0 | 4.0 | 4.0 | 4.0 |
| (b)/(c) (mass ratio) | 2.0 | 2.0 | 2.0 | 2.0 | 2.0 | 2.0 | 2.0 | 2.0 |

| | | | | | | | | | |
|---|---|---|---|---|---|---|---|---|---|
| Evaluation | Washing rate (%) | 73 | 77 | 72 | 70 | 89 | 93 | 75 | 73 |
| result | Stain spreading rate (%) | 134 | 133 | 135 | 131 | 127 | 128 | 125 | 124 |

| | | | | Examination example | | | | | | |
|---|---|---|---|---|---|---|---|---|---|---|
| | | | | 1-25 | 1-26 | 1-27 | 1-28 | 1-29 | 1-30 | 1-31 |
| Wiping | Formulation | Component (a1) | (a1-1) | | | | | | | 2 |
| detergent | composition | | (a1-2) | | | | | | | |
| composition | (mass %) | | (a1-3) | | | | | | | |
| for textile | | | (a1-4) | | | | | | | |
| products | | | (a1-5) | 1 | | | 4 | | | |
| | | | (a1-6) | | 1 | | | 4 | | |
| | | | (a1-7) | | | 1 | | | 4 | |
| | | Component (a1′) | (a1′-1) | | | | | | | |
| | | | (a1′-2) | | | | | | | 2 |
| | | | (a1′-3) | | | | | | | |
| | | | (a1′-4) | | | | | | | |
| | | Component (b) | (b1-1) | | | | | | | |
| | | Component (c) | (c-1) | 0.5 | 0.5 | 0.5 | 0.5 | 0.5 | 0.5 | 0.5 |
| | | Optional | (e-1) | 0.4 | 0.4 | 0.4 | 0.4 | 0.4 | 0.4 | 0.4 |
| | | component | (e-2) | 0.3 | 0.3 | 0.3 | 0.3 | 0.3 | 0.3 | 0.3 |

| | |
|---|---|
| (e-3) | Amounts required tor adjusting pH to the followings |

| | | | | | | | |
|---|---|---|---|---|---|---|---|
| Ton exchange water | Balance | Balance | Balance | Balance | Balance | Balance | Balance |
| Total | 100 | 100 | 100 | 100 | 100 | 100 | 100 |

| | | | | | | | |
|---|---|---|---|---|---|---|---|
| pH (25° C.) | 7.8 | 7.8 | 7.8 | 8.8 | 9.8 | 7.8 | 7.8 |
| (a1)/(b) (mass ratio)* | 1.0 | 1.0 | 1.0 | 4.0 | 4.0 | 4.0 | 4.0 |
| (b)/(c) (mass ratio) | 2.0 | 2.0 | 2.0 | 2.0 | 2.0 | 2.0 | 2.0 |

| | | | | | | | | |
|---|---|---|---|---|---|---|---|---|
| Evaluation | Washing rate (%) | 74 | 78 | 70 | 80 | 82 | 72 | 81 |
| result | Stain spreading rate (%) | 136 | 135 | 138 | 130 | 133 | 131 | 130 |

| | | | | Examination example | | | | | | |
|---|---|---|---|---|---|---|---|---|---|---|
| | | | | 1-32 | 1-33 | 1-34 | 1-35 | 1-36 | 1-37 | 1-38 |
| Wiping | Formulation | Component (a1) | (a1-1) | | | | | | | |
| detergent | composition | | (a1-2) | | | | | | | |
| composition | (mass %) | | (a1-3) | | | | | | | |
| for textile | | | (a1-4) | | | | | | | |
| products | | | (a1-5) | | | | | | | |
| | | | (a1-6) | | | | | | | |
| | | | (a1-7) | | | | | | | |
| | | Component (a1′) | (a1′-1) | | | | | 4 | | |
| | | | (a1′-2) | | | | | | 4 | |
| | | | (a1′-3) | | | | | | | 4 |
| | | | (a1′-4) | | | | | | | |
| | | Component (b) | (b1-1) | | | | | | | 1 |
| | | Component (c) | (c-1) | 0.5 | 0.5 | 0.5 | 0.5 | 0.5 | 0.5 | 0.5 |
| | | Optional | (e-1) | 0.4 | 0.4 | 0.4 | 0.4 | 0.4 | 0.4 | 0.4 |
| | | component | (e-2) | 0.3 | 0.3 | 0.3 | 0.3 | 0.3 | 0.3 | 0.3 |

| | |
|---|---|
| (e-3) | Amounts required tor adjusting pH to the followings |

| | | | | | | | |
|---|---|---|---|---|---|---|---|
| Ton exchange water | Balance | Balance | Balance | Balance | Balance | Balance | Balance |
| Total | 100 | 100 | 100 | 100 | 100 | 100 | 100 |

| | | | | | | | |
|---|---|---|---|---|---|---|---|
| pH (25° C.) | 7.8 | 7.8 | 7.8 | 7.8 | 7.8 | 7.8 | 7.8 |
| (a1)/(b) (mass ratio)* | 1.0 | 1.0 | 1.0 | 1.0 | 4.0 | 4.0 | 4.0 |
| (b)/(c) (mass ratio) | 2.0 | 2.0 | 2.0 | 2.0 | 2.0 | 2.0 | 2.0 |

| | | | | | | | | |
|---|---|---|---|---|---|---|---|---|
| Evaluation | Washing rate (%) | 50 | 54 | 49 | 63 | 61 | 58 | 52 |
| result | Stain spreading rate (%) | 131 | 133 | 127 | 138 | 125 | 126 | 123 |

*values of (a1′)/(b) are listed for examination examples 1-32 to 1-38.

### Examination Example 2

Detergent compositions were formulated with the following components.

<Component (a2)>
(a2-1): polyoxyethylene (5) lauryl ether (average number of added moles of oxyethylene group: 5, HLB: 10.8, manufactured by Kao Corporation)
(a2-2): alkyl trimethyl ammonium chloride (the alkyl group is a mixed alkyl group of lauryl group/myristyl group=70/30 (mass ratio))
<Component (b)>

The values inside the parentheses are calculated values of ClogP calculated using ChemProperty of ChemBioDraw Ultra ver. 14.0 from Perkin Elmer Inc.

(b1-1): ethanol (−0.24)
(b2-1): propylene glycol (−1.1)
<Component (c)>

The value inside the parentheses is a calculated value of ClogP calculated using ChemProperty of ChemBioDraw Ultra ver. 14.0 from Perkin Elmer Inc.

(c-1): 2-phenoxyethanol (1.2)
<Component (d)>
(d1-1): dimethylpolysiloxane emulsion (active ingredient 15 mass %, DK Q1-1247, manufactured by Dow Corning Toray Co., Ltd.)
(d1-2): silicone (KF-96, 10,000 cs, manufactured by Shin-Etsu Chemical Co., Ltd.)
(d2-1): silica particles (AEROSIL200, manufactured by NIPPON AEROSIL CO., LTD.)

### <Optional Components>

(e-1): tris(hydroxymethyl)aminomethane
(e-2): citric acid
(e-3): caustic soda (1 mass % aqueous solution, used as a pH adjuster)

### <Preparation of Wiping Detergent Compositions for Textile Products>

Detergent compositions listed in Tables 3 and 4 were prepared as follows using the aforementioned formulation components. Component (a2), component (b), component (c), component (d) and optional components other than the pH adjuster were put into a 100 mL glass beaker, to which ion exchange water (50° C.) in an amount of 90 mass % of a required amount was added and into which a stirrer piece (made of Teflon®, 3 cm long) was put, and which was sealed with Saran Wrap®, and the contents were stirred for 10 minutes. After stirred for 10 minutes, the contents were transferred to a water bath filled with water at 5° C. and cooled while stirred until the temperature of the contents reached 25° C. Using a pH meter equipped with a glass pH electrode, the pH was adjusted to a predetermined level by adding the pH adjuster. Ion exchange water was added to make the contents 100 mass %. The pH of the final compositions was measured and listed in Tables 3 and 4. A method for measuring pH is the same as in examination example 1. Note that, in Tables 3 and 4, the content of each formulation component is the amount of an active component.

### <Washing Test>

### (1) Pre-Washing of Test Cloth

Commercially available TC broadcloth (cotton/polyester ratio=65/35, purchased from Senshoku Shizai Kabushikikaisha Tanigashira Shoten) was cut into sheets each with a size of 1 m×1 m, which were prepared as many as a number equivalent to a mass of about 1.5 kg. EMULGEN 108 (polyoxyethylene alkyl ether, manufactured by Kao Corporation) was dissolved in city water in an amount of 500 mg/kg and washing operation was performed three times in an automatic washing machine (manufactured by TOSHIBA CORPORATION, model number: AW-8D3M). The bath ratio was 20 and the water temperature was 15° C. After that, they were rinsed under running water until no bubbles appeared, dried, and then used.

### (2) Preparation of Curry-Soiled Cloth

The pre-washed sheets of TC broadcloth were cut into 6 cm×6 cm pieces, three of which were stacked on top of one another, coated with 50 μl of curry (Soot Thai Red Curry, purchased at Kaldi) heated in a thermostatic bath at 50° C. in the shape of a circle with a diameter of 1 cm, and then, left to stand for 20 minutes under the circumstance at 23° C. and 50% RH. The top one of the three stacked pieces was used as a piece of curry-soiled cloth.

### (3) Method of Washing Test

A sheet-like spunlace nonwoven fabric (rayon/polypropylene/polyester ratio=80/10/10, basis weight 60 g/m², 150 mm×100 mm) was impregnated with each of the detergent compositions listed in Tables 3 and 4 at an impregnation rate listed in Table 3 relative to the nonwoven fabric to prepare a wiping washing sheet for textile products. A wiping test was conducted such that the stained surface of the piece of curry-soiled cloth was wiped with the washing sheet 50 times. Note that, in the wiping test with the washing sheet, washing operation was performed such that, every 10 times the stain attached to the textile product was wiped with one surface of the washing sheet making contact therewith, the surface was changed to the other, with which the stain was wiped. After wiped, the piece of curry-soiled cloth was left to stand for 12 hours under the circumstance at 25° C. and 60% RH.

### (4) Method for Evaluating Detergency

The reflectance of the stained surface of the piece of curry-soiled cloth after left to stand was measured (with NF777 manufactured by NIPPON DENSHOKU INDUSTRIES CO., LTD., range to be measured: a circle with a diameter of 5 mm at the center of the stain). A stain removal rate was calculated by the following formula, and the average value from measurements of three different pieces of curry-soiled cloth is listed in Tables 3 and 4. Note that reflectance (Z value) before wiping is Za, a Z value after wiping is Zb, and a Z value of white cloth is Zo.

Stain removal rate (%)=(Zb−Za)/(Zo−Za)×100

The higher a value of the stain removal rate is, the more excellent detergency is, and those with a stain removal rate of 70% or more are preferable.

### (5) Method for Evaluating Sliminess

Each wiping washing sheet for textile products prepared was picked up with a thumb and forefinger, and the fingers were shifted left and right 10 times to rub the washing sheet. The degrees of sliminess of the thumb and forefinger immediately after and 10 seconds after releasing the sheet were scored according to the following criteria to evaluate the sliminess. Evaluations were made by three persons, and the average value of the three persons' evaluation scores is listed in Tables 3 and 4. The smaller the evaluation score is, the further the sliminess can be reduced.

### Evaluation Criteria (Score)

5: sliminess was strongly felt both immediately thereafter and 10 seconds later
4: sliminess was strongly felt immediately thereafter and sliminess was slightly felt 10 seconds later
3: sliminess was slightly felt immediately thereafter and sliminess was also slightly felt 10 seconds later
2: sliminess was slightly felt immediately thereafter and sliminess was not felt at all 10 seconds later
1: sliminess was not felt at all immediately thereafter and since then

TABLE 3

| | | | | | Examination example | | | | |
|---|---|---|---|---|---|---|---|---|---|
| | | | | | 2-1 | 2-2 | 2-3 | 2-4 | 2-5 |
| Wiping | Wiping | Formulation | Component (a2) | (a2-1) | 2 | 2 | 2 | 2 | 2 |
| washing | detergent | composition | | (a2-2) | 0.1 | 0.1 | 0.1 | 0.1 | 0.1 |
| sheet for | composition | (mass %) | Component (b) | (b2-1) | 1 | 1 | 1 | 1 | 1 |
| textile | for textile | | | (b1-1) | 2 | 2 | 2 | 2 | 2 |
| products | products | | Component (c) | (c-1) | 0.5 | 0.5 | 0.5 | 0.5 | 0.5 |
| | | | Component (d) | (d1-1) | 0.015 | 0.005 | 0.015 | 0.08 | 0.015 |
| | | | | (d1-2) | | | | | |
| | | | | (d2-1) | | | | | |
| | | | Optional | (e-1) | 0.4 | 0.4 | 0.4 | 0.4 | 0.4 |
| | | | component | (e-2) | 0.3 | 0.3 | 0.3 | 0.3 | 0.3 |
| | | | | (e-3) | Amounts required for adjusting pH to the followings | | | | |
| | | | Ion exchange water | | Balance | Balance | Balance | Balance | Balance |
| | | | Total | | 100 | 100 | 100 | 100 | 100 |
| | | pH (25° C.) | | | 7.8 | 7.8 | 7.8 | 7.8 | 7.8 |
| | | (a2)/(b) | | | 0.7 | 0.7 | 0.7 | 0.7 | 0.7 |
| | | (b)/(c) (mass ratio) | | | 6.00 | 6.00 | 6.00 | 6.00 | 6.00 |
| | Impregnation rate (%) | | | | 200 | 300 | 300 | 300 | 350 |
| Evaluation | | | Washing rate (%) | | 70 | 76 | 76 | 80 | 80 |
| result | | | Sliminess (evaluation score) | | 1.3 | 2.7 | 2.3 | 1.0 | 2.7 |
| | | | | | Examination example | | | | |
| | | | | | 2-6 | 2-7 | 2-8 | 2-9 | 2-10 |
| Wiping | Wiping | Formulation | Component (a2) | (a2-1) | 2 | 2 | 2 | 2 | 2 |
| washing | detergent | composition | | (a2-2) | 0.1 | 0.1 | 0.1 | 0.1 | 0.1 |
| sheet for | composition | (mass %) | Component (b) | (b2-1) | 1 | 1 | 1 | 1 | 1 |
| textile | for textile | | | (b1-1) | 2 | 2 | 2 | 2 | 2 |
| products | products | | Component (c) | (c-1) | 0.5 | 0.5 | 0.5 | 0.5 | 5 |
| | | | Component (d) | (d1-1) | | | | | 0.015 |
| | | | | (d1-2) | 0.1 | | 0.1 | | |
| | | | | (d2-1) | | 0.3 | 0.3 | | |
| | | | Optional | (e-1) | 0.4 | 0.4 | 0.4 | 0.4 | 0.4 |
| | | | component | (e-2) | 0.3 | 0.3 | 0.3 | 0.3 | 0.3 |

| | |
|---|---|
| (e-3) | Amounts required for adjusting pH to the followings |

| | | | | | |
|---|---|---|---|---|---|
| Ion exchange water | Balance | Balance | Balance | Balance | Balance |
| Total | 100 | 100 | 100 | 100 | 100 |

| | | | | | |
|---|---|---|---|---|---|
| pH (25° C.) | 7.8 | 7.8 | 7.8 | 7.8 | 7.8 |
| (a2)/(b) | 0.7 | 0.7 | 0.7 | 0.7 | 0.7 |
| (b)/(c) (mass ratio) | 6.00 | 6.00 | 6.00 | 6.00 | 0.60 |

| | | | | | |
|---|---|---|---|---|---|
| Impregnation rate (%) | 300 | 300 | 300 | 300 | 300 |

| | | | | | | |
|---|---|---|---|---|---|---|
| Evaluation | Washing rate (%) | 78 | 80 | 78 | 80 | 80 |
| result | Sliminess (evaluation score) | 2.3 | 1.7 | 1.0 | 4.7 | 3.7 |

TABLE 4

| | | | | | Examination example | | | |
|---|---|---|---|---|---|---|---|---|
| | | | | | 2-11 | 2-12 | 2-13 | 2-14 |
| Wiping | Wiping | Formulation | Component (a2) | (a2-1) | 4 | 4 | 4 | 4 |
| washing | detergent | composition | | (a2-2) | 0.1 | 0.1 | 0.1 | 0.1 |
| sheet for | composition | (mass %) | Component (b) | (b2-1) | 0.5 | 1 | 1.5 | 2 |
| textile | for textile | | | (b1-1) | 0.5 | 1 | 1.5 | 2 |
| products | products | | Component (c) | (c-1) | 0.5 | 0.5 | 0.5 | 0.5 |
| | | | Component (d) | (d1-1) | 0.015 | 0.005 | 0.015 | 0.08 |
| | | | | (d1-2) | | | | |
| | | | | (d2-1) | | | | |
| | | | Optional | (e-1) | 0.4 | 0.4 | 0.4 | 0.4 |
| | | | component | (e-2) | 0.3 | 0.3 | 0.3 | 0.3 |
| | | | | (e-3) | Amounts required tor adjusting pH to the followings | | | |
| | | | Ion exchange water | | Balance | Balance | Balance | Balance |
| | | | Total | | 100 | 100 | 100 | 100 |
| | | pH (25° C.) | | | 7.8 | 7.8 | 7.8 | 7.8 |
| | | (a2)/(b) | | | 4.1 | 2.05 | 1.37 | 1.03 |
| | | (b)/(c) (mass ratio) | | | 2.00 | 4.00 | 6.00 | 8.00 |
| | Impregnation rate (%) | | | | 300 | 300 | 300 | 300 |
| Evaluation | | | Washing rate (%) | | 85 | 87 | 88 | 89 |
| result | | | Sliminess (evaluation score) | | 3.7 | 3.7 | 3.3 | 3.3 |
| | | | | | Examination example | | | |
| | | | | | 2-15 | 2-16 | 2-17 | 2-18 |
| Wiping | Wiping | Formulation | Component (a2) | (a2-1) | 4 | 4 | 1.5 | 2 |
| washing | detergent | composition | | (a2-2) | 0.1 | 0.1 | 0.1 | 0.1 |
| sheet for | composition | (mass %) | Component (b) | (b2-1) | 3 | 0.1 | 5 | 2 |
| textile | for textile | | | (b1-1) | 3 | 0.1 | 5 | 2 |
| products | products | | Component (c) | (c-1) | 0.5 | 0.2 | 0.5 | 0.5 |
| | | | Component (d) | (d1-1) | 0.015 | 0.015 | 0.015 | 0.015 |
| | | | | (d1-2) | | 0.1 | 0.1 | 0.1 |
| | | | | (d2-1) | | | | |
| | | | Optional | (e-1) | 0.4 | 0.4 | 0.4 | 0.4 |
| | | | component | (e-2) | 0.3 | 0.3 | 0.3 | 0.3 |

| | |
|---|---|
| (e-3) | Amounts required tor adjusting pH to the followings |

| | | | | |
|---|---|---|---|---|
| Ion exchange water | Balance | Balance | Balance | Balance |
| Total | 100 | 100 | 100 | 100 |

| | | | | |
|---|---|---|---|---|
| pH (25° C.) | 7.8 | 7.8 | 7.8 | 7.8 |
| (a2)/(b) | 0.7 | 20.5 | 0.16 | 0.525 |
| (b)/(c) (mass ratio) | 12.00 | 1.00 | 20.00 | 8.00 |

| | | | | |
|---|---|---|---|---|
| Impregnation rate (%) | 300 | 300 | 300 | 300 |

| | | | | | |
|---|---|---|---|---|---|
| Evaluation | Washing rate (%) | 90 | 84 | 68 | 69 |
| result | Sliminess (evaluation score) | 3.3 | 3.7 | 2.7 | 3 |

1. A wiping detergent composition for textile products comprising the following component (a1) in an amount of 0.3 mass % or more and 10 mass % or less, the following component (b) in an amount of 0.1 mass % or more, and water, wherein a mass ratio of the content of the component (a1) to the content of the component (b), (a1)/(b), is 0.6 or more and 50 or less,
component (a1): one or more surfactants selected from a nonionic surfactant with an HLB of 9 or more and 16.0 or less and an anionic surfactant, and
component (b): an organic solvent having a hydroxyl group with a ClogP of −2.0 or more and less than 1.0.

2. The wiping detergent composition for textile products according to claim 1, wherein the composition comprises the component (b) in an amount of 0.1 mass % or more and 5 mass % or less.

3. The wiping detergent composition for textile products according to claim 1, wherein the composition further comprises an organic solvent having a hydroxyl group with a ClogP of 1.0 or more and 2.2 or less [hereinafter referred to as a component (c)] in an amount of 0.1 mass % or more and 5 mass % or less.

4. The wiping detergent composition for textile products according to claim 3, wherein a mass ratio of the content of the component (b) to the content of the component (c), (b)/(c), is 1 or more.

5. The wiping detergent composition for textile products according to claim 1, wherein the component (b) is one or more selected from ethanol, 2-propanol, ethylene glycol and propylene glycol.

6. The wiping detergent composition for textile products according to claim 1, wherein the component (a1) is one or more selected from a nonionic surfactant including an ethyleneoxy group with an HLB of 9 or more and 16.0 or less and an anionic surfactant including any of a sulfonic acid group, a sulfate group and salts thereof.

7. The wiping detergent composition for textile products according to claim 1, wherein the content of the component (a1) is 20 mass % or more and 100 mass % or less in all surfactants contained in the composition.

8. A wiping detergent composition for textile products comprising the following component (a2) in an amount of 0.1 mass % or more and 10 mass % or less, the following component (b) in an amount of 0.1 mass % or more, the following component (d), and water, wherein a mass ratio of the content of the component (a2) to the content of the component (b), (a2)/(b), is 0.6 or more and 50 or less,
component (a2): a surfactant,
component (b): an organic solvent having a hydroxyl group with a ClogP of −2.0 or more and less than 1.0, and
component (d): a silicon compound.

9. The wiping detergent composition for textile products according to claim 8, wherein the composition further comprises an organic solvent having a hydroxyl group with a ClogP of 1.0 or more and 2.2 or less [hereinafter referred to as a component (c)] in an amount of 0.1 mass % or more and 5 mass % or less.

10. The wiping detergent composition for textile products according to claim 9, wherein a mass ratio of the content of the component (b) to the content of the component (c), (b)/(c), is 1 or more.

11. The wiping detergent composition for textile products according to claim 8, wherein the component (b) is one or more selected from ethanol, 2-propanol, ethylene glycol and propylene glycol.

12. The wiping detergent composition for textile products according to claim 8, wherein the component (a2) is one or more surfactants selected from a nonionic surfactant and an anionic surfactant.

13. The wiping detergent composition for textile products according to claim 8, wherein the component (a2) is a nonionic surfactant including an ethyleneoxy group with an HLB of 9 or more and 15 or less.

14. The wiping detergent composition for textile products according to claim 8, wherein the component (d) is one or more compounds selected from a silicone compound and an inorganic silicon compound.

15. A wiping washing sheet for textile products comprising the wiping detergent composition for textile products according to claim 1 and a base material.

16. The wiping washing sheet for textile products according to claim 15, wherein a percentage of the mass of the detergent composition to the mass of the base material is 100 mass % or more and 700 mass % or less.

17. A method for removing a stain attached to a textile product comprising, impregnating the stained portion of the textile product with the wiping detergent composition for textile products according to claim 1, and thereafter wiping the stained portion with a base material.

18. A method for removing a stain attached to a textile product comprising, impregnating a base material with the wiping detergent composition for textile products according to claim 1, and thereafter wiping the stained portion of the textile product with the impregnated base material.
